(19) United States
(12) Patent Application Publication
(10) Pub. No.: US 2008/0022205 A1
(43) Pub. Date: Jan. 24, 2008

(54) Recording control device and recording control method, and program

(76) Inventors: Mitsutoshi Shinkai, Kanagawa (JP); Takayoshi Kawamura, Kanagawa (JP); Yoshiaki Shibata, Kanagawa (JP); Nobuhiro Kotaka, Kanagawa (JP)

Correspondence Address: William S. Frommer, Esq.;FROMMER LAWRENCE & HAUG LLP, 745 Fifth Avenue, New York, NY, 10151, US

(21) Appl. No.: 11/879,323

(22) Filed: Jul. 17, 2007

(30) Foreign Application Priority Data
Jul. 19, 2006 (JP) 2006-196942

(51) Int. Cl. G06F 3/00

(52) U.S. Cl. 715/723

(57) ABSTRACT

A recording control device, whereby data recorded on a first recording medium is recorded on a second recording medium, includes a receiving unit and a recording control unit. The receiving unit is configured to receive a command from a user relating to editing. The recording control unit is configured to create creating editing information serving as information relating to the editing results of the data recorded on the first and second recording medium, and record the creating editing information on the second recording medium, and also to record, to the second recording medium, creating editing data serving as data which is, of the data recorded on the first recording medium data, data configuring editing results corresponding to the creating editing information.

### CROSS REFERENCES TO RELATED APPLICATIONS

The present invention contains subject matter related to Japanese Patent Application JP 2006-196942 filed in the Japanese Patent Office on Jul. 19, 2006, the entire contents of which are incorporated herein by reference.

### BACKGROUND OF THE INVENTION

1. Field of the Invention

The present invention relates to a recording control device and recording control method, and program, and particularly relates to a playback device and playback method, and program configured to improve work efficiency of a user in the case of consolidating editing results of data recorded in multiple recording media into one recording medium.

2. Description of the Related Art

A picture recording playback device which creates a playback list wherein picture audio files recorded in multiple memory cards are to be played back is disclosed in Japanese Unexamined Patent Application Publication No. 2005-236950. With this picture recording playback device, upon a user specifying playback in accordance with a playback list, picture audio files recorded on multiple memory cards are played consecutively based on the playback list, and output.

Also, a picture recording playback device is known which creates a playback list, in the event of recording data in a recording medium, so that the data therein is played back in the sequence of recording.

### SUMMARY OF THE INVENTION

However, in the event of consolidating editing results of data recorded on multiple recording media into one recording medium, with the picture recording playback device described in the above Japanese Unexamined Patent Application Publication No. 2005-236950, a user has needed to first perform editing work, then instruct playback according to a playback list, meaning that the work efficiency of the user has been poor.

There has been recognized the need to improve the work efficiency of the user in the event of consolidating editing results of data recorded on multiple recording media onto one recording medium.

According to an embodiment of the present invention, a recording control, device whereby data recorded on a first recording medium is recorded on a second recording medium, includes: a receiving unit configured to receive a command from a user relating to editing; and a recording control unit configured to create creating editing information serving as information relating to the editing results of the data recorded on the first and second recording medium, and record the creating editing information on the second recording medium, and also to record, to the second recording medium, creating editing data serving as data which is, of the data recorded on the first recording medium data, data configuring editing results corresponding to the creating editing information.

The recording control device may further include a display control unit configured to display thumbnail pictures, wherein the data is picture data, wherein the display control unit displays thumbnail pictures corresponding to the picture data recorded on the first or second recording medium, and wherein the receiving unit receives commands relating to the editing according to operations by the user as to the thumbnail pictures displayed with the display control unit.

The display control unit may display a first thumbnail picture corresponding to picture data recorded on the first or second recording medium in a first display region, and also displays a second thumbnail picture corresponding to the creating editing data in a second display region, wherein the receiving unit receives a command relating to the editing corresponding to operations for moving the first thumbnail picture to a predetermined position in the second display region, and wherein, according to commands received at the receiving unit, the recording control unit creates the creating editing information with picture data corresponding to the first thumbnail picture serving as an object of the operations, as picture data of a playback sequence corresponding to the predetermined position configuring the editing results, and records the creating editing information on the second recording medium, and also records the creating editing data from the data recorded on the first recording medium onto the second recording medium.

The recording control unit may create the creating editing information and record the creating editing information on the second recording medium, with the creating editing data from the data recorded on the first recording medium and the data of a predetermined length before and after the playback sequence of the creating editing data also being recorded on the second recording medium.

The recording control unit may further add data of a predetermined length before and after the playback sequence of the creating editing data, to the creating editing data recorded on the second recording medium.

First editing information serving as information relating to editing results of the data recorded on the first recording medium may be recorded on the first recording medium, and second editing information serving as information relating to editing results of the data recorded on the second recording medium, recorded on the second recording medium, with the recording control unit creating creating editing information of the first and second editing data configuring the editing results corresponding to the first and second editing information recorded on the first and second recording media and recording the creating editing information on the second recording medium, and also recording the creating editing data from the first editing data recorded on the first recording medium onto the second recording medium, according to commands received by the receiving unit.

According to an embodiment of the present invention, a recording control method for a recording control device wherein data recorded on a first recording medium is recorded on a second recording medium, includes the steps of receiving a command from a user relating to editing, creating creating editing information serving as information relating to the editing results of the data recorded in the first and second recording medium according to the received command, and recording, to the second recording medium, the creating editing information on the second recording medium, and also recording the creating editing data serving as data which is, of the data recorded on the first recording medium data, data configuring editing results corresponding to the creating editing information.

According to an embodiment of the present invention, a program for causing a computer to execute processing wherein data recorded on a first recording medium is recorded on a second recording medium, includes the steps of receiving a command from a user relating to editing, creating creating editing information serving as information relating to the editing results of the data recorded on the first and second recording medium according to the received command, and recording, to the second recording medium, the creating editing information on the second recording medium, and also recording the creating editing data serving as data which is, of the data recorded on the first recording medium data, data configuring editing results corresponding to the creating editing information.

According to embodiments of the present invention, a command relating to editing is received from a user, the creating editing information serving as information relating to the editing results of the data stored in the first and second recording media is created according to the received command, and this is recorded on the second recording medium, and also the creating editing data serving as data configuring the editing results corresponding to the creating editing information from the data recorded on the first recording medium is recorded on the second recording medium.

The recording control device may be an independent device, or may be a block performing recording control processing for the recording playback device.

Thus, in the event of consolidating editing results of data recorded in multiple recording media into one recording medium, work efficiency of the user is improved.

### BRIEF DESCRIPTION OF THE DRAWINGS

FIG. 1 is a diagram of a configuration example according to an embodiment of a simplified editing system applying the present invention;

FIG. 2 is a block diagram illustrating a configuration example of hardware for a video editing device;

FIG. 3 is a block diagram illustrating a functional configuration example of a consolidating unit;

FIG. 4 is a diagram illustrating an example of a directory configuration of a file recorded on an optical disk;

FIG. 5 is a diagram illustrating a format example of a clip file;

FIG. 6 is a diagram illustrating an example of an editing screen;

FIG. 7 is a diagram illustrating an example of another editing screen;

FIG. 8 is a diagram illustrating an example of yet another editing screen;

FIG. 9 is a diagram illustrating an example of yet another editing screen;

FIG. 10 is a diagram illustrating an example of yet another editing screen;

FIG. 11 is a diagram illustrating an example of yet another editing screen;

FIG. 12 is a diagram illustrating an example of yet another editing screen;

FIG. 13 is a diagram illustrating an example of an edit list;

FIG. 14 is a flowchart describing pre-consolidating processing;

FIG. 15 is a flowchart describing consolidating processing without a margin;

FIG. 16 is a flowchart describing details of edit list create processing;

FIG. 17 is a flowchart describing consolidating processing with a margin;

FIG. 18 is a flowchart describing processing for choices to be requested;

FIG. 19 is a flowchart describing edit list change processing;

FIG. 20 is a flowchart describing editing processing;

FIG. 21 is a block diagram illustrating another functional configuration example of the consolidating unit;

FIG. 22 is a flowchart describing another consolidating processing without margin;

FIG. 23 is a block diagram illustrating yet another consolidating processing without margin;

FIG. 24 is a diagram illustrating an example of a margin changing screen;

FIG. 25 is a flowchart describing adding of margin data;

FIG. 26 is a flowchart describing another pre-consolidating processing;

FIG. 27 is a flowchart describing adding processing;

FIG. 28 is a diagram of another example of the edit list;

FIG. 29 is a block diagram illustrating yet another functional configuration example of the consolidating unit;

FIG. 30 is a diagram illustrating yet another example of an editing screen;

FIG. 31 is a diagram illustrating yet another example of an editing screen;

FIG. 32 is a diagram illustrating yet another example of an editing screen;

FIG. 33 is a flowchart describing yet another pre-consolidating processing;

FIG. 34 is a flowchart describing another processing without margin;

FIG. 35 is a flowchart describing pre-editing processing; and

FIG. 36 is a flowchart describing another editing processing.

### DESCRIPTION OF THE PREFERRED EMBODIMENTS

A specific embodiment to which the present invention has been applied will be described in detail with reference to the drawings.

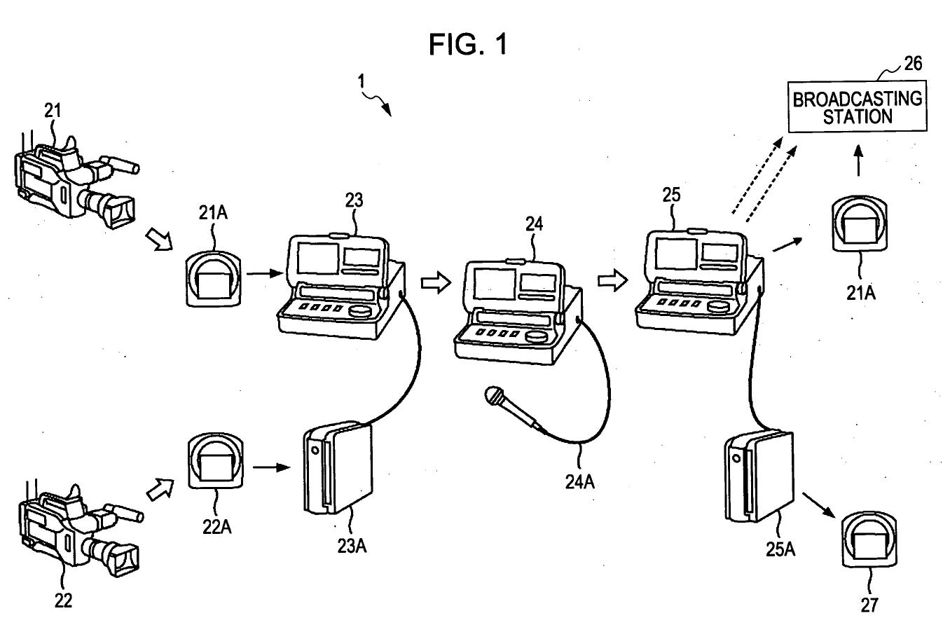

FIG. 1 illustrates a configuration example according to an embodiment of a simplified editing system to which the present invention has been applied. The simplified editing system 1 of FIG. 1 is a simplified editing system used for simplified consolidation of a collection of television programs, for example. The process for simple consolidation of a television program is basically divided into disk consolidation, video editing, voice-over addition, and intermediate package transmitting or intermediate package recording.

Disk consolidation is a process to consolidate unprocessed data such as picture data or audio data for each scene making up a television program stored on multiple optical disks onto one optical disk. Video editing is a process to perform non-linear editing by selecting a necessary range of unprocessed data and arranging this in a desired sequence.

Voice-over adding is a process to add a voice-over to the editing results by recording voice-over data so that voice-over data serving as audio data such as narration is played back simultaneously with the unprocessed data making of the editing results of the video editing (hereafter called editing data). Intermediate package transmitting is a process to transmit editing results after voice-over adding as a intermediate package to a broadcasting station or the like. Note that a intermediate package indicates incomplete data wherein finishing by superimposing characters or shapes has not yet been performed. Intermediate package recording is a process to record the intermediate package on an optical disk or the like.

The simplified editing system 1 in FIG. 1 is a simplified editing assisting system configured to assist with work with such various processes. The simplified editing system 1 comprises camcorders 21 and 22, a video editing device 23, voice-over adding device 24, and intermediate package recording device 25.

The camcorders 21 and 22 are devices for use with storing a news program which is a television program, or picture-capturing (including capture of audio) of sporting event situations or movies or the like. The camcorders 21 and 22 record the unprocessed data obtained by shooting an object or the like on an optical disk 21A or optical disk 22A in units of files.

Also, the camcorders 21 and 22 generates information which will be usable for video editing during a latter step, such as information relating to storing, based on input by the user, and associates this as metadata to the unprocessed data obtained with the camcorders 21 and 22.

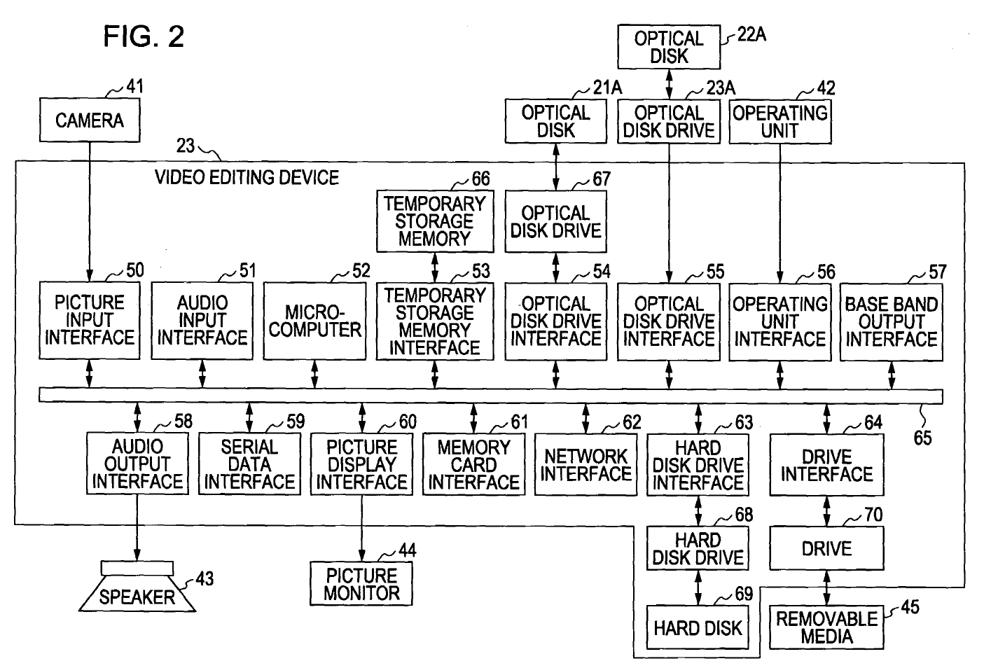

The optical disk 21A or 22A wherein unprocessed data or metadata associated thereto is recorded is mounted on an optical disk drive 67 within the video editing device 23 (FIG. 2 to be described later) or an external optical disk drive 23A.

The video editing device 23 is a device used for non-linear editing of unprocessed data of various scenes making up a television program stored on the optical disk 21A or 22A mounted on the internal optical disk drive 67 or external optical disk drive 23A, and for consolidating editing data to either one of the optical disks 21A or 22A.

Note that hereafter, description will be made with the understanding that the editing data consolidating destination (copy destination) is the optical disk 21A, and the consolidating origin (copy source) is the optical disk 22A.

The video editing device 23 performs non-linear editing of the unprocessed data recorded on the optical disk 21A or 22A according to input by the user, creates an edit list (editing information) which is information relating to the editing results thereof, and records this to the optical disk 21A, and also copies the editing data and so forth from the unprocessed data recorded on the optical disk 22A to the optical disk 21A.

The voice-over adding device 24 is a device used to add the voice-over to the editing results obtained from the video editing device 23. The optical disk 21A wherein the unprocessed data and edit list are recorded is mounted on the voice-over adding device 24, and a microphone 24A is also connected thereto.

The voice-over adding device 24 plays back the editing data according to the edit list recorded on the optical disk 21A, and adds the audio input in the microphone 24A during playback to the editing results as a voice-over. That is to say, the voice-over adding device 24 records the voice-over data on the optical disk 21A so that the voice-over data which is audio data input during playback of the editing data is played back at the same time as the editing data during playback.

The intermediate package recording device 25 is a device used for transmitting or recording as intermediate package of the editing results after adding the voice-over. The optical disk 21A after the voice-over data being recorded in the internal drive (not shown) by the voice-over adding device is mounted on the intermediate package recording device 25, and according to the edit list recorded in the optical disk 21A, the unprocessed data and voice-over data recorded in the optical disk 21A are simultaneously played back as a intermediate package, and the intermediate package thereof is transmitted as a base band to the broadcasting station 26 using an FPU (Field Pickup Unit) or SNG (Satellite News Gathering).

Also, the intermediate package recording device 25 connects the editing data recorded on the optical disk 21A according to the edit list recorded on the optical disk 21 after the voice-over data is recorded, over-writes the voice-over data of a predetermined channel on the audio data of a predetermined channel included in the editing data thereof, and transmits the resulting unprocessed data as an integrated intermediate package to the broadcasting station 26 following FTP (File Transfer Protocol) or FAM (File Access Mode). FAM is a format for sending and receiving file format data from data handling formats in iLINK®.

The broadcasting station 26 creates an optical disk or the like wherein a file with an integrated intermediate package is recorded, by recording a file with an integrated intermediate package on an unshown optical disk or the like. Note that an arrangement may be made wherein the optical disk 21A in which the voice-over data is recorded, is mailed to the broadcast station 26. The broadcast station 26 uses the blank packet transmitted from the intermediate package recording device 25 as described above to perform finishing with superimposing of characters or shapes, and creates a complete package which is AV (Audio Video) completed as a television program.

Note that the file with integrated intermediate package may be arranged to be recorded in an unrecorded region wherein nothing is recorded, or to be recorded on an optical disk 27 mounted on the drive 25A connected to the intermediate package recording device 25.

In FIG. 1, the camcorders 21 and 22, video editing device 23, voice-over adding device 24, and intermediate package recording device 25 are each shown as separate devices, but all of these devices, or a part thereof, may be integrated into a single device.

Further, with FIG. 1, the optical disks 21A and 22A are mounted on the optical disk drive 67 inside the video editing device 23 or the external optical disk drive 23A, and the video editing device 23 performs reading or recording as to the mounted optical disk 21A and 22A, but an arrangement may be made wherein the video editing device 23 is connected to the camcorder 21 whereupon the optical disk 21A is mounted and the camcorder 22 whereupon the optical disk 22A is mounted, via a network, thus performing reading or recording as to the optical disks 21A and 22A via the network.

Hereafter, in the event there is no need to distinguish the camcorders 21 and 22, these will be collectively called camcorder 20.

FIG. 2 is a block diagram showing a configuration example of the hardware for the video editing device 23 in FIG. 1. With the video editing device 23 in FIG. 2, a picture input interface 50, audio input interface 51, microcomputer 52, temporary memory interface 53, optical disk drives interface 54 and 55, operating unit interface 56, base band output interface 57, audio output interface 58, serial data interface 59, picture display interface 60, memory card interface 61, network interface 62, hard disk drive IF 63, and drive interface 64 are connected to a system bus 65 via a data bus.

An externally provided camera 41 is connected to the picture input interface 50, wherein picture signals obtained as a result of shooting with the camera 41 are input from the camera 41. Synchronization signals such as signals following SDI (Serial Digital Interface) standards, composite signals, and component signals which are included in the picture signals are supplied to the picture display interface 60 and so forth as picture data via the system bus 65.

Audio signals of ambient sound obtained by the unshown microphone or the like are input into the audio input interface 51. The audio input interface 51 performs A/D (Analog/Digital) conversion as to the audio signals thereof and supplies the resulting digital signals to the audio output interface 58 and so forth via the system bus 65.

The microcomputer 52 comprises a CPU (Central Processing Unit), ROM (Read Only Memory), and RAM (Random Access Memory). The CPU of the microcomputer 52 controls the various parts of the video editing device 23 according to operation signals or the like from the operation unit interface 56, following the program recorded in the ROM or hard disk 69. Programs to be executed by the CPU or data are stored in the RAM as appropriate.

The temporary memory 66 such as a buffer is connected to the temporary memory interface 53, wherein the temporary memory interface 53 stores proxy data supplied from the optical disk drive interface 54 or 55 in the temporary memory 66. This proxy data is data with a smaller amount of unprocessed data.

Also, the temporary memory interface 53 supplies audio data from the proxy data stored in the temporary memory 66 in the audio output interface 58 via the system bus 65, and supplies picture data to the picture display interface 60 via the system bus 65.

The optical disk drive 67 whereupon the optical disk 21A is mounted is connected to the optical disk drive interface 54. The optical disk drive interface 54 controls the optical disk drive 67 to read proxy data from the optical disk 21A and supply this to the temporary memory interface 53 via the system bus 65, or reads unprocessed data and supplies this to the base band output interface 57 via the system bus 65. Also, the optical disk drive interface 54 controls the optical disk drive 67 to record the edited data supplied from the optical disk drive interface 55 on the optical disk 21A.

The optical disk drive 23A whereupon the optical disk 22A is mounted is connected to the optical disk drive interface 55. The optical disk drive interface 55 controls the optical disk drive 23A to read the proxy data from the optical disk 22A, and supplies this to the temporary memory interface 53 via the system bus 65. Also, the optical disk drive interface 55 controls the optical disk drive 23A to read the editing data from the optical disk 22A and supplies this to the optical disk drive interface 54.

An operating unit 42 such as a receiving unit which receives commands transmitted from an externally provided keyboard, mouse, or remote control is connected to the operating unit interface 56. The operating unit interface 56 generates operating signals according to operations of the operating unit 42 by the user, and supplies these operating signals to the microcomputer 52 via the system bus 65.

The base band output interface 57 outputs the unprocessed data from the optical disk drive interface 54 to the FPU device or SNG device as a base band. For example, the base band output interface 57 outputs the editing data supplied from the optical disk drive interface 54 to the FPU device or SNG device as a base band.

An externally provided speaker 43 is connected to the audio output interface 58, and the audio output interface 58 performs D/A (Digital/Audio) conversion as to the audio data supplied from the audio input I/f 51, amplifies the resulting analog signal, and supplies this to the speaker 43. The speaker 43 outputs the audio to the outside based on the analog signals from the audio output interface 58. Note that an arrangement may be made wherein the audio output interface 58 supplies the audio data as is to the speaker 43, the speaker 43 performs D/A conversion, and the audio is output to the outside based on the resulting analog signals.

The serial data interface 59 handles the data as necessary, between digital equipment such as an unshown external computer or the like. An externally provided picture monitor 44 is connected to the picture display interface 60, wherein the picture display interface 60 performs D/A conversion as to the picture data from the temporary memory interface 53, amplifies the analog signals such as the resulting composite signal, component signal, or the like, and supplies this to the picture monitor 44. The picture monitor 44 displays pictures based on the analog signals from the picture display interface 60.

Note that an arrangement may be made wherein, along with the picture, a time code corresponding to the picture may be displayed on the picture monitor 44. Also, an arrangement may be made wherein the picture display interface 60 supplies the picture data as is to the picture monitor 44, wherein the picture monitor 44 performs D/A conversion, and the picture is displayed based on the resulting analog signals.

The memory card interface 61 performs reading/writing of picture data, audio data, various types of setting data and so forth as to the memory card (not shown) which is mounted on the video editing device 23, as necessary. The network interface 62 handles the data between other devices connected via a network such as the Internet or a Local Area Network, as necessary.

For example, the network interface 62 obtains a program from another device via the network, and records this onto the hard disk 69 via the system bus 65, hard disk drive interface 63, and hard disk drive 68.

A hard disk drive 68 whereupon the hard disk 69 is mounted is connected to the hard disk drive interface 63. The hard disk drive interface 63 controls the hard disk drive 68 to read/write the data as to the hard disk 69. For example, the hard disk drive interface 63 controls the hard disk drive 68 to record the programs supplied via the network interface 62 and system bus 65 onto the hard disk 69.

A drive 70 is connected to the drive interface 64. The drive interface 64 controls the drive 70, and when a removable media 45 such as a magnetic disk, optical disk, optical magnetic disk, or semiconductor memory is mounted on the drive 70, the drive interface 64 drives these, and obtains the program or data recorded therein. The obtained program or data is transferred to the hard disk 69 via the hard disk drive interface 63 and so forth, as necessary. The system bus 65 mediates the data handling between the various parts connected via a data bus.

Next, with the video editing device 23 in FIG. 2, the microcomputer 52 functions as an consolidating unit for consolidating the editing data to the optical disk 21A by executing predetermined programs.

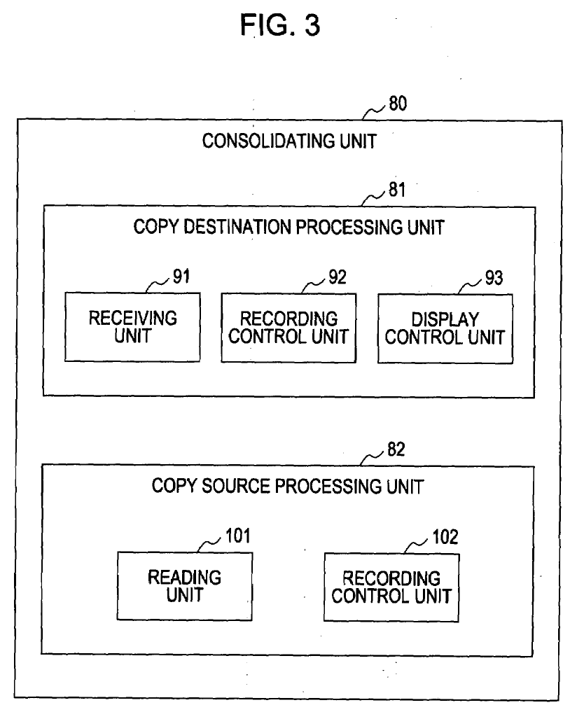

FIG. 3 shows a functional configuration example of such an consolidating unit 80. The consolidating unit 80 shown in FIG. 3 comprises a copy destination processing unit 81 for performing processing as to the optical disk 21A serving as the copy destination (consolidation destination), and a copy source processing unit 82 for performing processing as to the optical disk 22A serving as the copy source (consolidation origin).

The copy destination processing unit 81 comprises a receiving unit 91, recording control unit 92, and display control unit 93. The receiving unit 91 receives operating signals corresponding to operations for performing commands relating to editing, which is supplied from the operating unit interface 56 of the FIG. 2, and supplies the operating signals to the recording control unit 92 or the display control unit 93.

The recording control unit 92 performs non-linear editing of the unprocessed data recorded in the optical disks 21A and 22A according to operating signals from the receiving unit 91, and also consolidates the resulting editing data in the optical disk 21A. Specifically, the recording control unit 92 creates an edit list which is information relating to the editing results of the unprocessed data recorded on the optical disks 21A and 22A according to operating signals from the receiving unit 91, and controls the optical disk drive interface 54 to record this on the optical disk 21A.

Also, the recording control unit 92 creates an edit list in increments of clips (hereafter called clip edit list) which is information relating to editing data in increments of clips (hereafter called sub-clips) according to the operating signals from the receiving unit 91, and transmits this to the recording control unit 102 of the copy source processing unit 82.

Note that a clip is a unit of the number of times of shooting processing with the camcorder 20. Also, besides this, the clip may indicate a unit showing the time of the shooting processing from shooting start until shooting end, or may indicate a unit showing the length of various types of data obtained by the shooting processing, or may indicate a unit showing the data amount of the various types of data obtained with the shooting processing. Further, a clip may also indicate the consolidate itself of the various types of data. Here, a clip indicates the consolidation of the unprocessed data, metadata, and so forth obtained from the first shooting processing (the shooting processing from shooting start to shooting end), for example.

Further, the recording control unit 92 requests a sub-clip from the unprocessed data recorded on the optical disk 22A, or a sub-clip to which unprocessed data of a predetermined length, in the playback sequence before and after the sub-clip, is attached (hereafter called margin data) from the reading unit 101 of the copy source processing unit 82, and records the sub-clip or the sub-clip to which margin data is attached transmitted according to the request thereof onto the optical disk 21A.

Thus, the recording control unit 92 records not only the sub-clip but also the margin data on the optical disk 21A as necessary, so in the event of performing editing to change the starting position or ending position of the editing segment within the range of margin data, editing data is consolidated on the optical disk 21A and therefore newly recording the sub-clip only to optical disk 21A is not necessary. Consequently, efficiency of the editing work by the user can be improved.

The display control unit 93 is displayed on various screens on the picture monitor 44 according to the operating signals from the receiving unit 91. Specifically, for example, the display control unit 93 controls the optical disk drive interface 54 according to the operating signals from the receiving unit 91 to read out the proxy data recorded on the optical disk 21A and also requests reading of the proxy data recorded on the optical disk 22A from the copy source processing unit 82, and receives the proxy data transmitted according to the request thereof.

Also, the display control unit 93 creates picture data for displaying a thumbnail picture (hereafter called thumbnail picture data), based on the proxy data of the leading picture, for example, from the proxy data read out from the optical disks 21A or 22A. The display control unit 93 then controls the picture display interface 60 to display an editing screen which is a screen for the user to perform commands relating to editing, using thumbnail picture data and so forth.

The user performs commands relating to editing by operating the operating unit 42 while viewing the editing screen displayed on the picture monitor 44. The operating signals corresponding to these commands are received by the receiving unit 91.

The copy source processing unit 82 comprises a reading unit 101 and recording control unit 102. The reading unit 101 controls the optical disk drive interface 55 according to the request from the recording control unit 92 to read the sub-clip whereto the margin data is attached, and supplies this to the recording control unit 92. The reading unit 101 controls the optical disk drive interface 55 to read the proxy data from the optical disk 22A and supplies this to the display control unit 93, according to the request from the display control unit 93. The recording control unit 102 controls the optical disk drive interface 55 to record the clip edit list from the recording control unit 92 on the optical disk 22A.

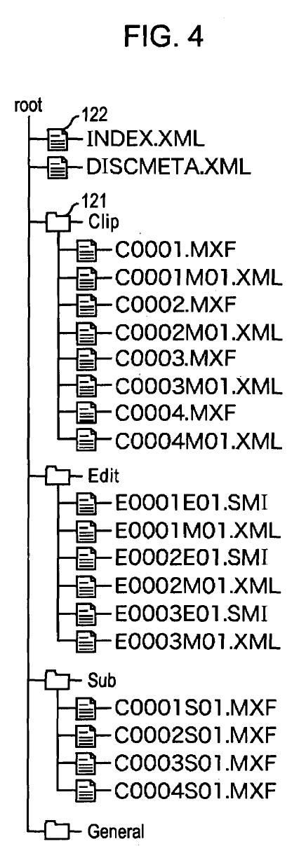

FIG. 4 shows an example of a directory configuration of files recorded on the optical disk 21A. In FIG. 4, a symbol denoted by reference numeral 121 indicates one directory. Note that each of the other symbols which are shown as being the same as the symbol (directory) 121 also indicates one directory, though not denoted by reference numeral. Also, a symbol denoted by reference numeral 122 indicates one file. Note that that each of the other symbols which are shown as being the same as the symbol (file) 122 also indicate one file, though not denoted by reference numeral.

Note that hereafter, as long as there is no significant difference, the directory and the directory symbol will be considered to be the same thing and discussed accordingly. Similarly, the file and the file symbol will be considered to be the same thing and discussed accordingly. Also, in order to facilitate identification of the various files, the name of the file or directory will be written in parentheses ( ) after the file or directory.

In the example in FIG. 4, an index file (INDEX.XML) 122 describing the information for managing clips and edit lists, which is a file of data describing an index, and a disk metafile (DISCMETA.XML) which is a file of disk metadata describing the representative pictures of the optical disk 21A and the title of the optical disk 21A or comments, are provided on the optical disk 21A.

Also, a clip directory (Clip) 121 wherein a clip file is provided at the lower portion thereof, an edit list directory (Edit) wherein an edit list file is provided at the lower portion thereof, and a proxy directory (Sub) wherein a proxy data file is provided at the lower portion thereof, are provided on the optical disk 21A.

A clip recorded on the optical disk 21A is recorded in the clip directory (Clip) 121 as different files for each clip. Specifically, for example, FIG. 4 shows an example wherein four clip data are recorded on the optical disk 21A. That is to say, for example, a first clip file (C0001.MXF) which is a file of the unprocessed data of the first clip recorded on the optical disk 21A, and a non-real-time metadata file (C0001M01.XML) which is a file including metadata not requesting real-time properties, which corresponds to the unprocessed data of the clip, are provided at the lower portion of the clip directory 121.

Note that in the example in FIG. 4, the non-real-time metadata file (C0001M01.XML) is described in XML format to allow for general use properties. Also, as with the first clip file (C0001.MXF) and first non-real-time metadata file (C0001M01.XML), a second clip file (C0002.MXF) and second non-real-time metadata file (C0002M01.XML), a third clip file (C0003.MXF) and third non-real-time metadata file (C0003M01.XML), and a fourth clip file (C0004.MXF) and fourth non-real-time metadata file (C0004M01.XML), are provided on the lower portion of the clip directory 121.

In FIG. 4, an edit list recorded on the optical disk 21A is recorded in the edit directory (Edit) shown on the lower portion of such a clip directory (Clip) 121, as different files for each editing process.

For example, in the case of FIG. 4, a first edit list file (E0001E01.SMI) serving as a file including an edit list which is information relating to the editing results of the first editing processing of the clip recorded on the optical disk 21A, and a first edit list metadata file (E0001M01.XML) serving as a file including metadata corresponding to the edited data (the portions of the unprocessed data of all clips used in the editing which are extracted as editing data) or metadata newly generated based on the metadata thereof, are provided on the lower portion of the edit directory (Edit).

Also, as with the first edit list file (E0001E01.SMI) and first edit list metadata file (E0001E01.XML), a second edit list file (E0002E01.SMI) corresponding to the second editing processing of the clips recorded on the optical disk 21A and a second edit list metadata file (E0002E01.XML), and a third edit list file (E0003E01.SMI) corresponding to the third editing processing of the clips recorded on the optical disk 21A and a third edit list metadata file (E0003E01.XML), are provided on the lower portion of the edit directory.

Also, in FIG. 4, proxy data of the clip recorded on the optical disk 21A is recorded on the proxy directory (Sub) shown on the lower portion of such an edit directory (Edit), as different files for each clip. For example, in the case of the example in FIG. 4, a first proxy file (C0001S01.MXF) serving as a proxy data file of the first clips recorded on the optical disk 21A, a second proxy file (C0002S01.MXF) serving as a proxy data file of the second clips, a third proxy file (C0003S01.MXF) serving as a proxy data file of the third clips, and a fourth proxy file (C0004S01.MXF) serving as a proxy data file of the fourth clips, are provided on the lower portion of the proxy directory (Sub).

Further, a general directory (General), wherein data files other than the data relating to the clips are provided, is provided on the optical disk 21A. Note that the directory configuration of the files recorded on the optical disk 22A is also similar to the directory configuration shown in FIG. 4.

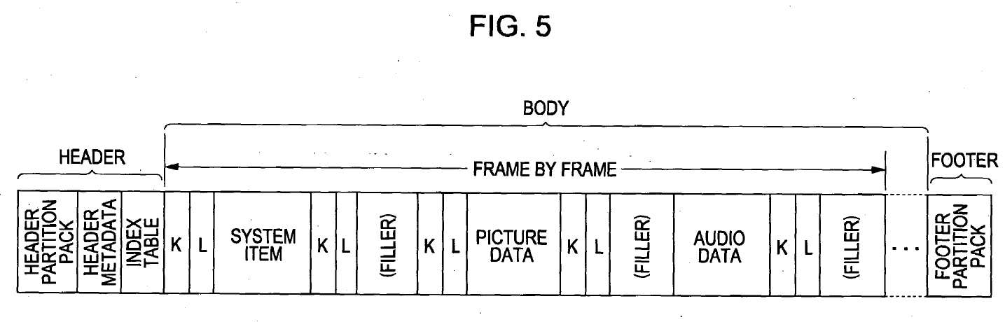

FIG. 5 shows an example of formatting of the clip files in FIG. 4. FIG. 5 shows formatting of the unprocessed data to be disposed in a file body in each case of using picture data encoded with MPEG (Moving Picture Experts Group) 2 and audio data in linear PCM (Pulse Code Modulation) format. Note that picture data and audio data of various types of formatting such as DV (Digital Video) as well can be disposed in the body.

As shown in FIG. 5, a system item wherein the metadata requesting one frame worth of real-time properties (hereafter called real-time metadata) is disposed, the picture data encoded with the MPEG2 method, and the audio data encoded with the linear PCM format are disposed in the body collectively as one clip worth, and further, a header and a footer are attached to the body, thus configuring the clip file.

The system item, picture data, and audio data are disposed in a KLV (Key, Length, Value) configuration and subjected to KLV coding. KLV configuration is a configuration where Key, Length, and Value are disposed in that sequence from the front. A 16 byte label following SMPTE 298M standards showing what type of data is the data disposed in Value, is disposed in the Key. Data length of the data disposed in Value is disposed in Length. An actual value, i.e. the system item wherein one frame worth of real-time metadata is disposed, picture data, or audio data is disposed in Value.

The data length of the system item subjected to KLV coding, the picture data, and audio data are of a fixed length subject to KAG (KLV Alignment Grid) standards. In order for the system item subjected to KLV coding, the picture data, and audio data to have a fixed length, a Filler serving as data for the purpose of stuffing is arranged as KLV configuration, and disposed after each of the system item subjected to KLV coding, the picture data, and audio data.

Within the header, a Header Partition Pack, a Header Metadata, and an Index Table are disposed in that sequence from the leading edge of the header. Partition metadata serving as data showing the file format (for example, MXF (Material exchange Format)), the length of the body, the start position of the body, the format (encoding method) for the data to be disposed in the body, and so forth are disposed in the Header Partition Pack. An MPUMID (Material Package Unique Material Identifier), an FPUMID (File Package UMID), a leading edge time code, the file create data, and information relating to the data disposed in the body (for example, the number of pixels in an picture, aspect ratio and the like) are disposed in the Header Metadata.

Note that an MPUMID is a unique identifier for identifying the data disposed in the body in a globally unique manner, and indicates an identifier established by the SMPTE (Society of Motion Picture and Television Engineers). Also, the FPUMID is a unique identifier for identifying the file in a globally unique manner, established by the SMPTE.

Data for managing the data disposed in the body is disposed in the Index Table. The footer comprises a Footer Partition Pack, and data for specifying the footer or the like is disposed in the footer Partition Pack.

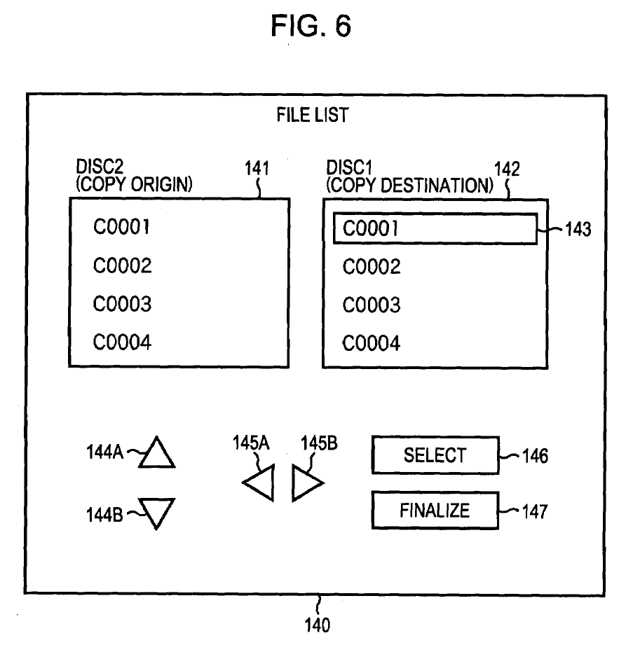

Next, FIGS. 6 through 12 are diagrams showing an example of the editing screen displayed by the display control unit 93 in FIG. 3.

First, upon the user commanding the start of video editing, a clip selection screen 140 in FIG. 6, which is one of the editing screens, is displayed on the picture monitor 44. The clip selection screen 140 in FIG. 6 comprises a copy source display portion 141, a copy destination display portion 142, cursor 143, upper direction button 144A and lower direction button 144B, left direction button 145A and right direction button 145B, selection button 146, and finalizing button 147.

The name of the clip file recorded on the optical disk 22A serving as the copy source is displayed on the copy source display portion 141. In the example in FIG. 6, the file directory configuration of the optical disk 22A is of the directory configuration shown in FIG. 4, wherein the clip file (C0001.MXF through C0004.MXF) names “C0001”, “C0002”, “C0003”, “C0004” are displayed on the copy source display portion 141.

The name of the clip file recorded on the optical disk 21A serving as the copy destination is displayed on the copy destination display portion 142. In the example in FIG. 6, the file directory configuration of the optical disk 21A is the directory configuration shown in FIG. 4, wherein the clip file (C0001.MXF through C0004.MXF) names “C0001”, “C0002”, “C0003”, “C0004” are displayed on the copy destination display portion 142.

The cursor 143 is displayed at a position corresponding to the name of the clip file displayed in the copy source display portion 141 or the copy destination display portion 142. The cursor 143 is operated when the user selects a predetermined clip file, and is moved to a position corresponding to the display position of the name of the desired clip file of the user.

The upper direction button 144A is operated to move the cursor 143 in the upper direction, and the lower direction button 144B is operated to move the cursor 143 in the lower direction. The left direction button 145A is operated to move the cursor 143 in the left direction, and the right direction button 145B is operated to move the cursor 143 in the right direction.

The selection button 146 is operated when the clip file corresponding to the position of the cursor 143 is selected as the clip file of interest to be edited. The finalizing button 147 is operated when finalizing the selection of the clip file of interest.

With FIG. 6, the user operates the upper direction button 144A, lower direction button 144B, left direction button 145A, and right direction button 145B while viewing the name of the clip files displayed in the copy source display portion 141 and the copy destination display portion 142, then moves the cursor 143 to the position corresponding to the name of the clip file of interest to be edited, operates the selection button 146, and then operates the finalizing button 147. Thus, the selection of the clip file of interest to be edited is chosen.

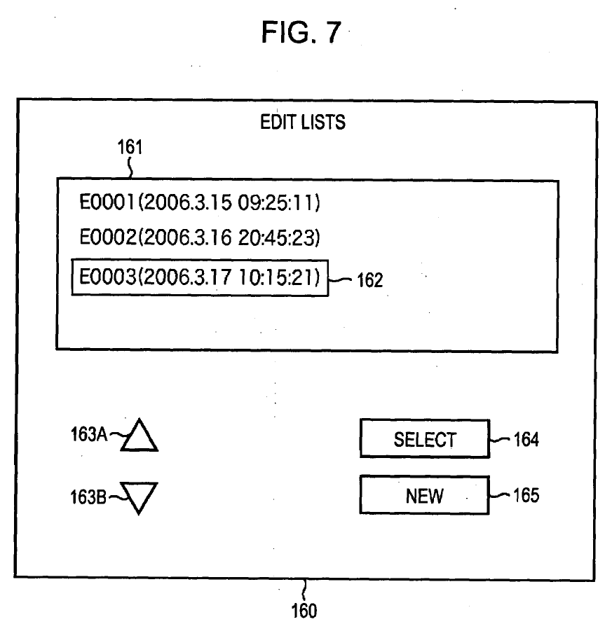

Upon the user operating the finalizing button 147, the clip selection screen 140 in FIG. 6 is changed to the edit list selection screen 160 in FIG. 7 which is one of the editing screens.

The edit list selection screen 160 in FIG. 7 comprises an edit list display portion 161, cursor 162, upper direction button 163A and lower direction button 163B, a selection button 164, and a new button 165.

The name of the edit list file recorded on the optical disk 21A serving as the copy destination, and the create date/time thereof are displayed on the edit list display portion 161. In the example in FIG. 7, the directory configuration of the file recorded in the optical disk 21A is the directory configuration shown in FIG. 4. The first five characters of the names of the first through third edit list files, followed by the create date/time of the first through third edit list files in parentheses, are displayed on the edit list display portion 161.

The cursor 162 is displayed in a position corresponding to the name of the edit list file displayed in the edit list display portion 161 and the create date/time thereof. The cursor 162 is operated when the user selects a desired edit list file, and is moved in a position corresponding to the display position of the name and create date/time of the desired edit list file of the user.

The upper direction button 163A is operated to move the cursor 162 in the upper direction, and the lower direction button 163B is operated to move the cursor 162 in the lower direction. The selection button 164 is operated to update the edit list corresponding to the position of the cursor 162. The new button 165 is operated when creating a new edit list.

With FIG. 7, in the event of updating the edit list file with the editing hereafter, the user operates the upper direction button 163A or lower direction button 163B while viewing the name and create date/time of the edit list file displayed in the edit list display portion 161, then moves the cursor 162 to the position corresponding to the name of the edit clip file to be updated, and operates the selection button 164. Thus, the edit list file to be updated is determined.

Also, in the case of creating a new edit list file with the editing hereafter, the new button 165 is operated.

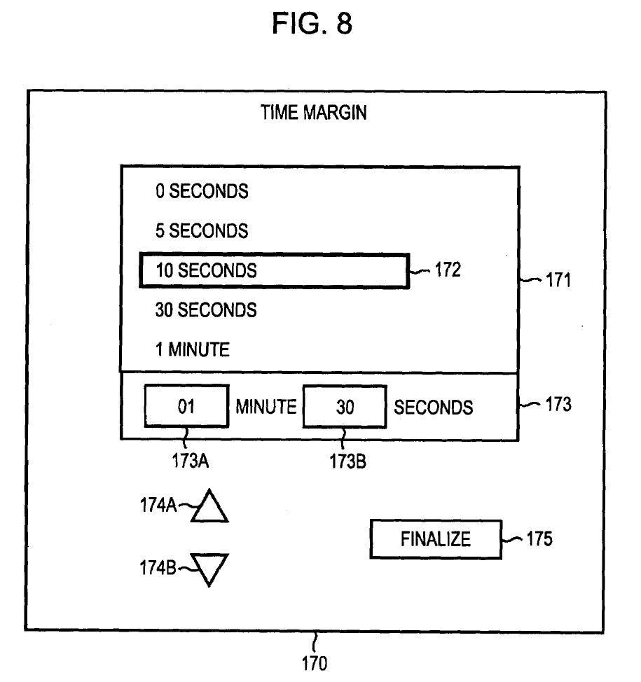

Upon the selection button 164 or the new button 165 being operated by the user, the edit list selection screen 160 in FIG. 7 is changed to the margin setting screen 170 in FIG. 8.

The margin setting screen 170 in FIG. 8 comprises a time selection portion 171, cursor 172, time input portion 173, upper direction button 174A, lower direction button 174B, and finalizing button 175.

The time selection portion 171 displays selection options for the playback time of the margin data attached before and after the sub-clip (hereafter called time margin). In the example in FIG. 8, “0 seconds”, “5 seconds”, “10 seconds”, “30 seconds”, and “1 minute” are displayed as selection options.

The cursor 172 is displayed at a position corresponding to the selection options displayed in the time selection portion 171 or in the time input portion 173. The cursor 172 is operated when the user selects a desired time margin, and is moved to a position corresponding to the desired time margin of the user. Also, the cursor 172 is operated when the user inputs a desired time margin, and is moved to the time input unit 173.

The time input portion 173 comprises a minute input portion 173A and a second input portion 173B, and is operated when the desired time margin is input. A number of the desired time margin in increments of minutes is input as a two-digit number in the minute input portion 173A. A number of the desired time margin in increments of seconds is input as a two-digit number in the second input portion 173B.

Upon the cursor 172 being moved to the time input portion 173, the cursor 172 is first displayed at a position corresponding to the minute input portion 173A. Now, upon a two-digit number being input by the user in the minute input portion 173A, the cursor 172 is moved to the second input portion 173B so that the user can input a two-digit number in the second input portion 173B.

The upper direction button 174A is operated to move the cursor 172 in the upper direction, and the lower direction button 174B is operated to move the cursor 172 in the lower direction. The finalizing button 175 is operated to finalize the margin data as the time margin currently selected as a selection option in the time selection portion 171, or the time margin currently input in the time input portion 173.

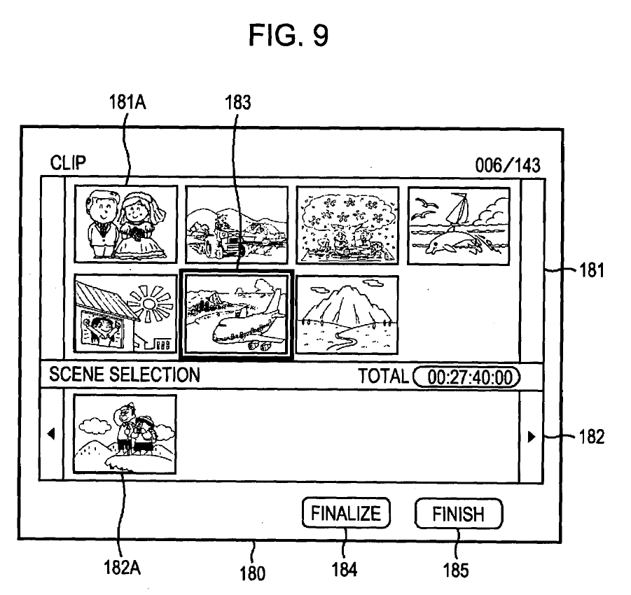

Upon the finalizing button 175 being operated and clip editing recorded in the optical disk 22A being commanded by the user, the margin setting screen 170 in FIG. 8 is changed to an optical disk 22A editing screen 180 in FIG. 9.

The optical disk 22A editing screen 180 in FIG. 9 comprises an edit object display portion 181, edit result display portion 182, cursor 183, finalizing button 184, and finish button 185.

The thumbnail pictures 181A corresponding to the clip file selected as the clip file of interest at the clip selection screen 140 in FIG. 6 and the clip files of a predetermined number before and after the playback sequence as to such clip file, from the clip files recorded in the optical disk 22A, are displayed in the edit object display portion 181. That is to say, the clip file selected as the clip file of interest, and the clip files of a predetermined number before and after the playback sequence as to such clip file, become edit objects, wherein the thumbnail pictures 181A of such edit objects are displayed in the edit object display portion 181.

In the example in FIG. 9, the clip file selected by the user and a total of six clip files including three clip files before and after the playback sequence as to this clip file, for a total of seven clip files, are to be edited, thereby the seven thumbnail pictures 181A corresponding to such edit objects are displayed in the edit object display portion 181.

Thumbnail pictures 182A of sub-clips corresponding to the edit list file selected in the edit list selection screen 160 in FIG. 7 are displayed in the edit result display portion 182 in the sequence of playback from the left side. Note that in the case that the new button 165 is operated at the edit list selection screen 160, nothing is displayed in the edit result display portion 182. In the example in FIG. 9, a thumbnail picture 182A of one sub-clip corresponding to the edit list file selected at the edit list selection screen 160 is displayed.

The cursor 183 is displayed in a position corresponding to the thumbnail picture 181A displayed in the edit object display portion 181. The cursor 183 is operated when the user selects the thumbnail picture 181A of a desired clip, and is moved to a position corresponding to the display position of the thumbnail picture 181A desired by the user.

The finalizing button 184 is operated when the selection of the thumbnail picture 181A corresponding to the cursor 183 is to be chosen. The finish button 185 is operated when editing of the clips recorded in the optical disk 22A is to be finished.

Note that in FIG. 9, a situation is described wherein editing of clips recorded in the optical disk 22A is commanded by the user, but even in a situation wherein editing of clips recorded in the optical disk 21A is commanded, the optical disk 21A editing screen is similarly displayed. In this case, the thumbnail pictures corresponding to the clip file selected as the clip file of interest at the clip selection screen 140 in FIG. 6 and the clip files of a predetermined number before and after the playback sequence as to such clip file, from the clip files recorded in the optical disk 21A, are displayed in the edit object display portion of the optical disk 21A editing screen.

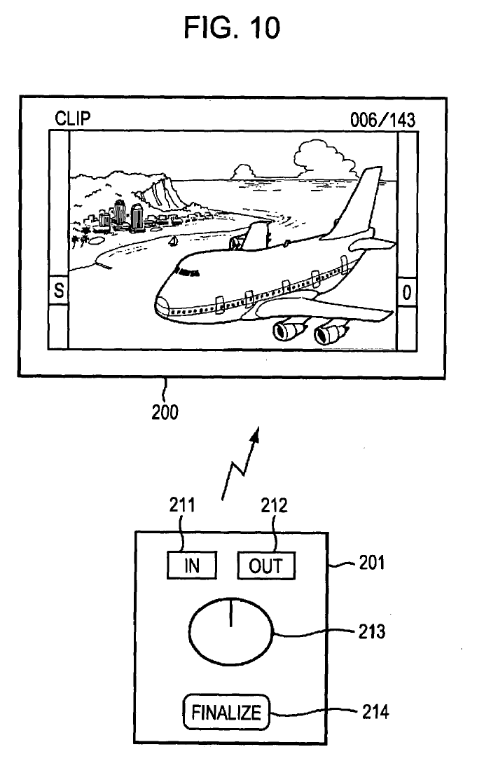

In FIG. 9, upon the finalizing button 184 being operated by the user, the optical disk 22A editing screen 180 in FIG. 9 is changed to an editing segment setting screen 200 in FIG. 10.

The editing segment setting screen 200 in FIG. 10 displays an picture of the clip corresponding to the thumbnail picture 182A wherein the cursor 183 is positioned when the finalizing button 184 is operated in FIG. 9.

At this time, the user uses a remote controller 201 to transmit commands to the operating unit 42, for example, and sets the editing segment by specifying an in point which is the starting position of the editing segment and an out point which is the finishing position of the editing segment. Specifically, an in point button 211, out point button 212, dial 213, and finalizing button 214 are provided on the remote controller 201.

The in point button 211 is operated when specifying the playback position corresponding to the picture displayed on the editing segment setting screen 200 as the in point. The out point button 212 is operated when specifying the playback position corresponding to the picture displayed on the editing segment setting screen 200 as the out point. The dial 213 is operated when displaying the picture within the same clip wherein the playback sequence is before or after the picture currently displayed, in the editing segment setting screen 200. The finalizing button 214 is operated when finalizing the in point and out point currently specified as the in point and out point as to the clip corresponding to the picture displayed in the editing segment setting screen 200.

In FIG. 10, upon the user operating the dial 213 as needed, whereby the picture corresponding to the desired in point is displayed in the editing segment setting screen 200, the user operates the in point button 211 to specify the in point. Also, upon the user operating the dial 213 as needed, whereby the picture corresponding to the desired out point is displayed in the editing segment setting screen 200, the user operates the out point button 212 to specify the out point. After this, the user finalizes the currently selected in point and out point as the in point and out point as to the clip corresponding to the picture displayed in the editing segment setting screen 200 by operating the finalizing button 214. Thus, the editing segment as to the clip corresponding to the thumbnail picture 181A selected in the optical disk 22A editing screen 180 in FIG. 9 is set.

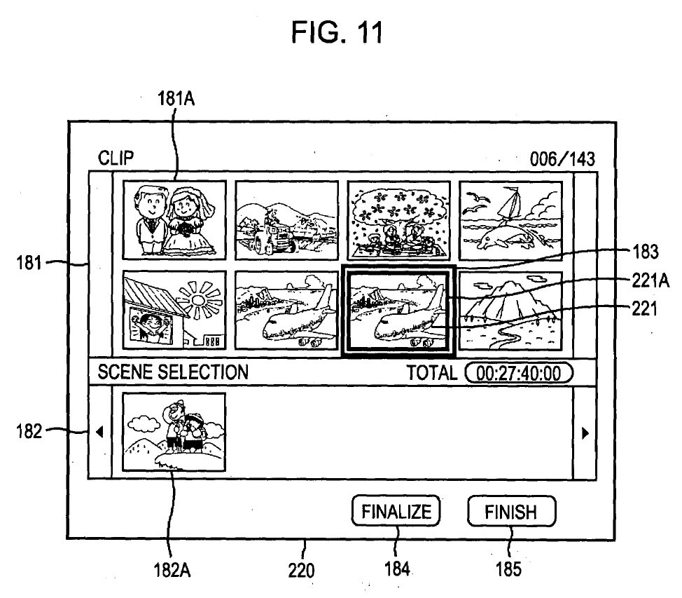

Upon the finalizing button 214 in FIG. 10 being operated, the editing segment setting screen 200 in FIG. 10 is changed to an optical disk 22A editing screen 220 in FIG. 11.

The optical disk 22A editing screen 220 in FIG. 11 is configured similarly to the optical disk 22A editing screen 181 in FIG. 9, but in addition to the seven thumbnail pictures 181A displayed in the edit object display portion 181, thumbnail picture 221 corresponding to unprocessed data of the editing segment set at the editing segment setting screen 200 in FIG. 10 is also displayed in the edit object display portion 181 in FIG. 11.

A frame 221A is attached to the thumbnail picture 221 which indicates that the thumbnail picture corresponds to the unprocessed data in the editing segment of the clip. Accordingly, the user can determine by the frame 221A or the lack thereof, whether the thumbnail picture displayed in the optical disk 22A editing screen 220 is a thumbnail picture corresponding to the unprocessed data of the editing segment of the clip or is a thumbnail picture corresponding to the clip itself.

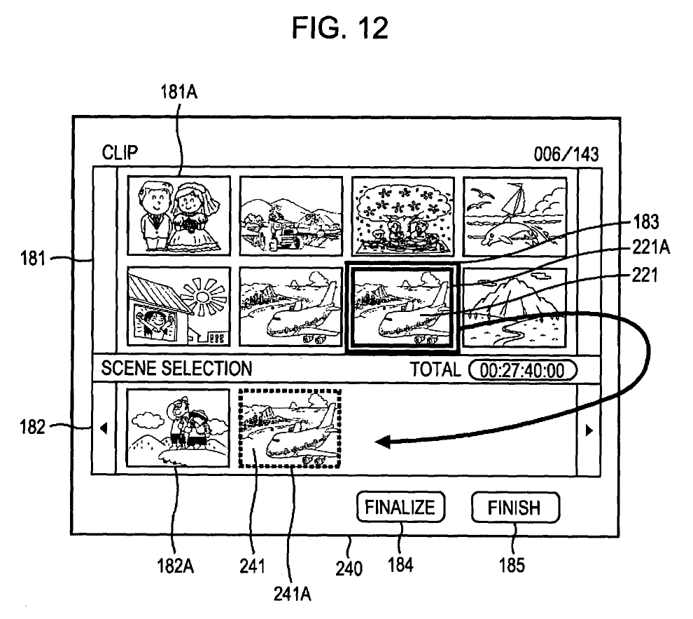

In FIG. 11, upon the user dragging the thumbnail picture 221 to the right side of the thumbnail picture 182A within the edit result portion 182 as a thumbnail picture of unprocessed data to be edited, the optical disk 22A editing screen 220 in FIG. 11 is changed to an optical disk 22A editing screen 240 in FIG. 12. That is to say, as shown in FIG. 12, a thumbnail picture 241 which has the same frame 241A attached as the thumbnail picture 221 to which the frame 221A is attached, is displayed in a translucent manner on the right side of the thumbnail picture 182A in the edit result display portion 182.

Following this, upon the user dropping the thumbnail picture 221, the thumbnail picture 221 to which the frame 221A is attached which has been displayed in the edit object display portion 181 is moved to the edit result display portion 182. That is to say, the thumbnail picture 241 to which the frame 241A is attached while being displayed in the edit result display portion 182 in a translucent manner is displayed in a solid manner, and the thumbnail picture 221 to which the frame 221A is attached which has been displayed in the edit object display portion 181 is deleted. Note that the cursor 183 is displayed in a position corresponding to the thumbnail picture 241.

Thus, upon the thumbnail picture 221 being dragged and dropped, the recording control unit 92 updates the edit list file corresponding to the edit result display portion 182 so that the unprocessed data corresponding to the thumbnail picture 241 is played back as a sub-clip following the sub-clip corresponding to the thumbnail picture 182A.

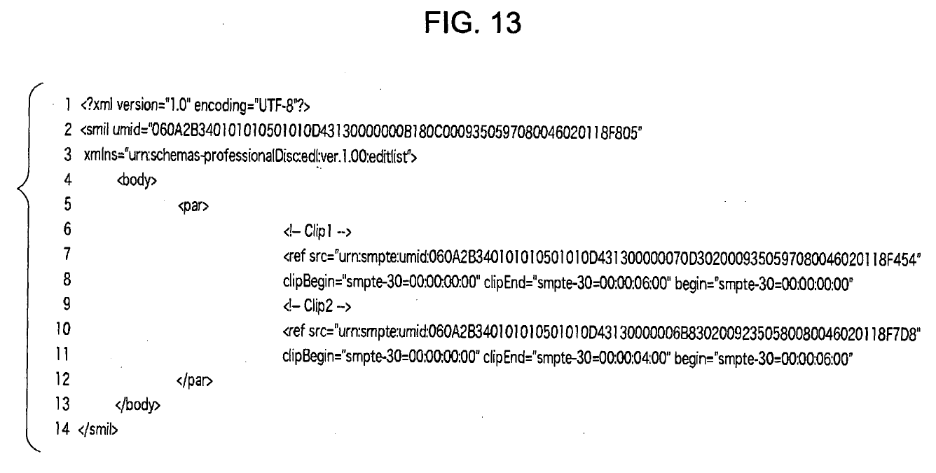

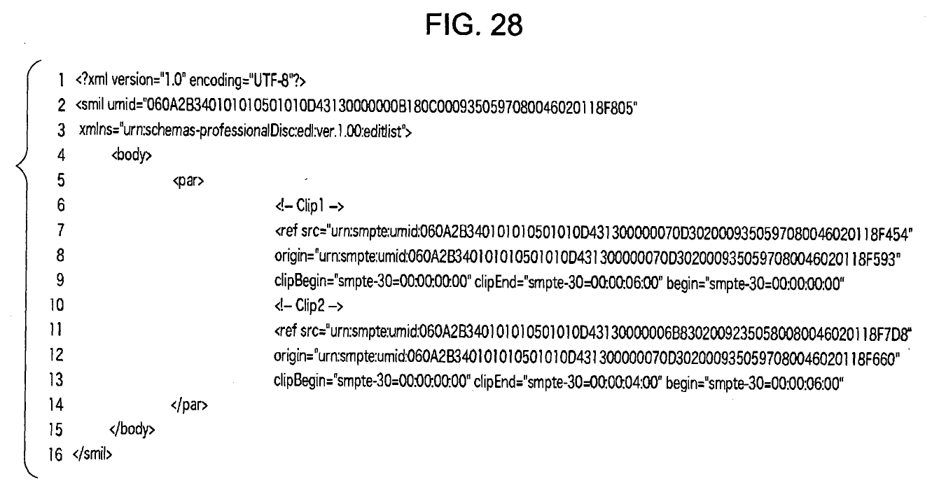

FIG. 13 shows an example of an edit list of the edit list file. That is to say, FIG. 13 is a diagram showing a specific description example of an edit list file written with XML. Note that with FIG. 13, the numbers at the beginning of each row are attached to facilitate description, and are not a part of XML writing. This also applies in FIG. 28 to be described later.

The edit list file is a file including an edit list which is information relating to the editing results of a non-linear editing (non-destructive editing) of a clip, and also describes a playback method of the editing results.

As shown in FIG. 13, the XML description of the edit list file is primarily configured of a body portion defined by body tags (<body> </body>). In the example in FIG. 13, this body portion is described in the fourth through thirteenth rows. Note that information showing that this file is an Edit List of a Professional Disc is described in the first through third rows.

To describe in detail, the information relating to temporal actions of editing description is described in the body portion. With the example in FIG. 13, the par element described between the start tag “<par>” in the fifth row and the end tag “</par>” in the twelfth row is a time container, whereby a simple time group for simultaneously playing back multiple elements is defined. With the example in FIG. 13, a first clip (described as Clip 1 in the example in FIG. 13, and for example may be a clip from the first clip file (C0001.MXF) in FIG. 4) and a second clip (described as Clip 2 in the example in FIG. 13, and for example may be a clip from the second clip file (C0002.MXF) in FIG. 4) are shown to be played back simultaneously.

However, in the case of the example in FIG. 13, as will be described later, the playback start time of the two clips are shifted as to one another, so actually the two clips are arranged to be played back consecutively.

In FIG. 13, a file to be referenced and the playback range of the file to be reference and so forth are described in the ref element in the seventh and eighth rows. The description of “src=“urn:smpte:umid”060A2B340101010501010D431300000070D3020009350597080046020118F454”” in the seventh row shows that the MPUMID assigned to the file at the reference destination is ““060A2B340101010501010D431300000070D3020009350597080046020118F454””.

Also, the description of “clipBegin=“smpte-30=00:00:00:00”” in the eighth row shows the in point of the first clip as a first clip FTC (File Time code), the unit of which is number of frames. Note that this FTC is relative positional information wherein the number of the first frame of each file is set to “0”, with each frame being assigned in sequence from the first frame. The description of “clipEnd=“smpte-30=00:00:06:00”” which follows in the eighth row shows the out point of the first clip with the FTC of the first clip.

Further, the description of “begin=“smpte-30=00:00:00:00”” in the eighth row which follows the description above shows the point-in-time of the first clip starting playback, i.e. the position of the edit list with the FTC wherein the sub-clip is started, the unit being number of frames. Note that “smpte-30” describes that the time code used is a SMPTE time code defined by SMPTE as thirty frames per second.

Thus, with the example in FIG. 13, the edit list is described such that the first clip starts playback at point-in-time “00:00:00:00” at the position of frame number “00:00:00:00”, and is played back until the position of frame number “00:00:06:00”.

Also, with the second clip also, the tenth and eleventh row describe the same thing as in the case of the first clip. With the example in FIG. 13, the edit list is described such that the second clip starts playback at point-in-time “00:00:06:00” at the position of frame number “00:00:00:00”, and is played back until the position of frame number “00:00:04:00”.

With the edit list in FIG. 13, the playback of the first clip and the playback of the second clip as described above are specified to be performed simultaneously with the par element. Accordingly, as a result, at point-in-time “00:00:00:00”, playback is performed from the position of the first clip of frame number “00:00:00:00” to the position of frame number “00:00:06:00”. Thus, at point-in-time “00:00:06:00”, playback is performed from the position of the second clip of frame number “00:00:00:00” to the position of frame number “00:00:04:00”. Thus, with the edit list shown in FIG. 13, the first clip and the second clip are shown to be edited so as to be consecutively played back.

In other words, the edit list in FIG. 13 shows that the first clip (Clip1) is played back for six seconds, following which the second clip (Clip2) is played back for four seconds.

Note that with FIG. 13, the example of the MPUMID indicating the various data is described as above, but this is only to show the description position and so forth of the MPUMID within the edit list, and this is a theoretical MPUMID wherein the values described have no meaning. That is to say, the MPUMID described in FIG. 13 is a combination of symbols without meaning which differs from an actual MPUMID, and in reality a MPUMID correctly created based on a method defined by SMPTE will be described in the various positions instead of the above-described theoretical MPUMID.

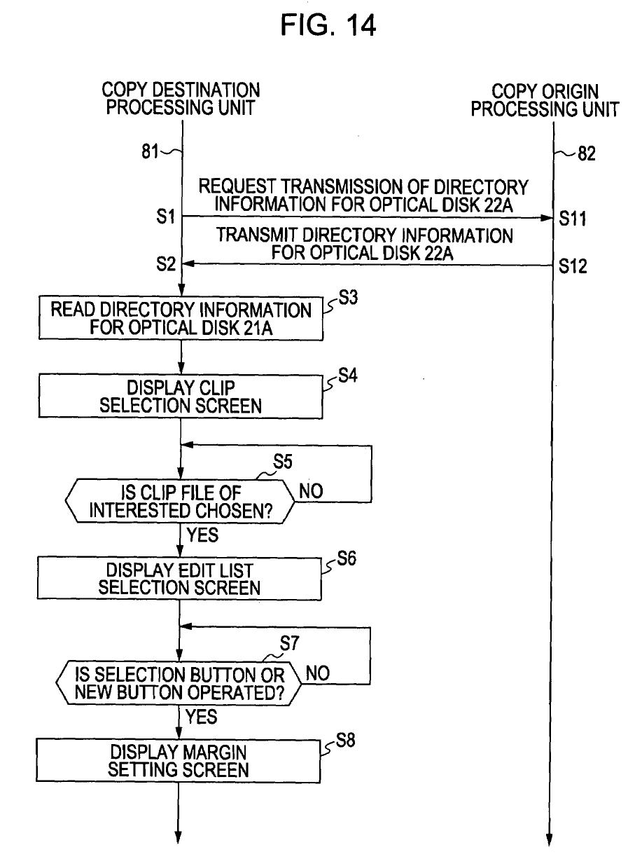

Next, a pre-consolidating process performed before the consolidating unit 80 in FIG. 3 performs consolidating of editing data will be described with reference to FIG. 14. This pre-consolidating processing is started when the user commands the start of video editing by operating the operating unit 42, for example.

In step S1, the display control unit 93 of the copy destination processing unit 81 requests transmission of directory information showing the directory configuration of a file recorded in the optical disk 22A to the reading unit 101 of the copy source processing unit 82, and the flow is advanced to step S2.

In step S11, the reading unit 101 receives the request from the display control unit 93 and the flow is advanced to step S12. In step S12, the reading unit 101 controls the optical disk drive interface 55 to read the directory information from the optical disk 22A, transmits the directory information thereof to the display control unit 93, and ends the processing.

In step S2, the display control unit 93 receives the directory information transmitted from the reading unit 101 and the flow is advanced to step S3. In step S3, the display control unit 93 controls the optical disk drive interface 54 to read the director information (FIG. 4) of the file recorded on the optical disk 21A, and the flow is advanced to step S4.

In step S4, the display control unit 93 displays the clip selection screen 140 in FIG. 6 as one editing screen on the picture monitor 44, based on the directory information of the optical disks 21A and 22A.

Specifically, the display control unit 93 displays the file names of all of the clip files recorded on the optical disk 22A at the copy source display portion 141, based on the directory information in the optical disk 22A. Also, similarly, the display control unit 93 displays the file names of all of the clip files recorded on the optical disk 21A at the copy destination display portion 142, based on the directory information in the optical disk 21A. Further, the display control unit 93 displays a cursor 143, upper direction button 144A, lower direction button 144B, left direction button 145A, right direction button 145B, selection button 146, and finalizing button 147.

Following the processing in step S4, the flow is advanced to step S5, wherein the display control unit 93 determines whether the selection of the clip file of interest to be edited is chosen by the user, i.e. whether the finalizing button 147 is operated by the user, according to the operation signal from the receiving unit 91, and in the event that determination is made that the selection of the clip file of interest is not chosen, the flow stands by until the selection of the clip file of interest is chosen.

On the other hand, in step S5, in the event that determination is made that the selection of the clip file of interest is chosen, the flow is advanced to step S6, wherein the display control unit 93 displays the edit list selection screen 160 shown in FIG. 7 based on the directory information of the optical disk 21A.

Specifically, the display control unit 93 displays the file names and create dates and times of all of the edit list files recorded on the optical disk 22A based on the directory information in the optical disk 22A at the edit list display portion 161. Also, the display control unit 93 displays a cursor 162, upper direction button 163A, lower direction button 163B, selection button 164, and new button 165.

Following the processing in step S6, the flow is advanced to step S7, wherein the display control unit 93 determines whether or not the select button 164 or new button 165 has been be operated according to the operating signal from the receiving unit 91, and the event that determination is made that the select button 164 or the new button 165 have not been operated, the flow stands by until such operation is performed.

On the other hand, in step S7, in the event that determination is made that the select button 164 or the new button 165 is operated, the flow is advanced to step S8, and the display control unit 93 displays the margin setting screen 170 in FIG. 8 and the processing is ended.

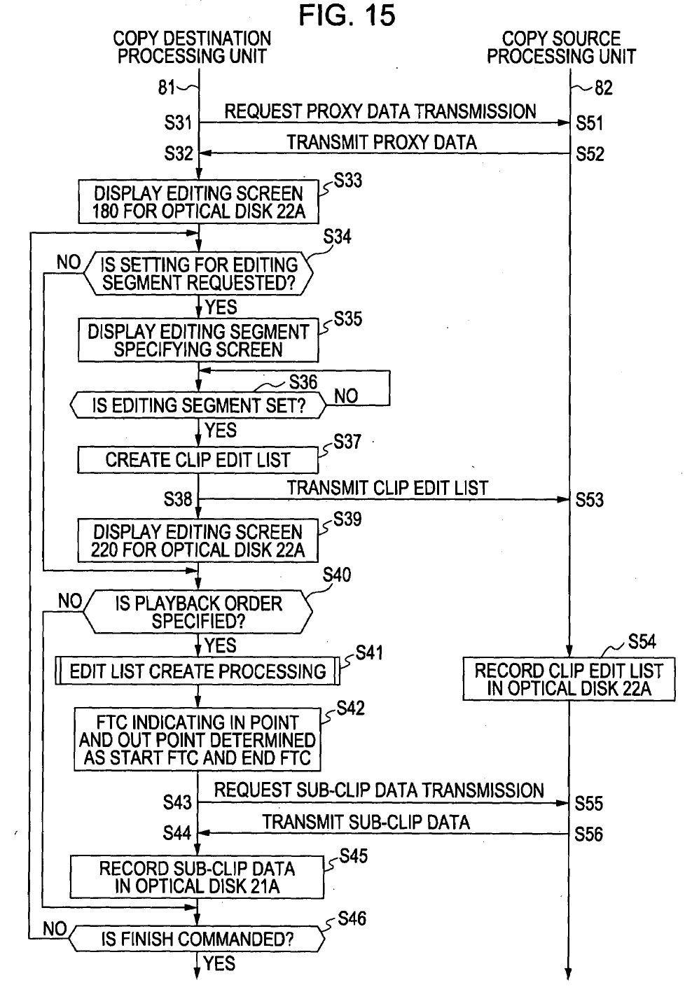

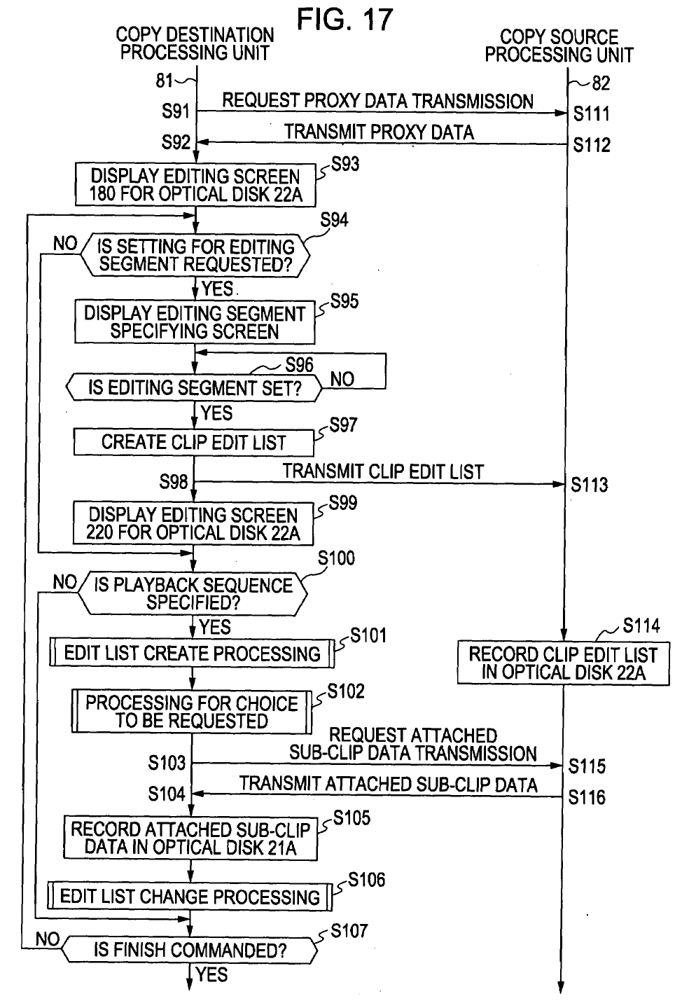

Following this, the user chooses a margin time by operating the operating unit 42 at the margin setting screen 170. In the event that the user sets 0 seconds as the margin time, the consolidating unit 80 in FIG. 3 performs consolidating processing without margin, which consolidates the editing data recorded on the optical disk 22A onto the optical disk 21A. The details of the consolidating processing without margin will be described later in FIG. 15. On the other hand, in the event that the user selects a margin time of other than 0 seconds, the consolidating unit 80 performs consolidating processing with margin, which consolidates the editing data with margin data is attached which is recorded on the optical disk 22A onto the optical disk 21A. The details of the consolidating processing with margin will be described later in FIG. 17.

The consolidating processing without margin by the consolidating unit 80 will be described with reference to FIG. 15. Note that in FIG. 15, the user commands editing of the clips recorded on the optical disk 22A.

In step S31, the display control unit 93 of the copy destination processing unit 81 requests transmission of proxy data corresponding to the clip files recorded on the optical disk 22A, from the clip files which selection has been chosen in step S5 in FIG. 14, from the reading unit 101 of the copy source processing unit 82, and the flow is advanced to step S32.

In step S51, the reading unit 101 receives the request transmitted from the display control unit 93, and the flow is advanced to step S52. In step S52, the reading unit 101 reads the proxy data corresponding to the clip files requested by the transmission from the display control unit 93 from the optical disk 22A and transmits this to the display control unit 93. The flow is then advanced to step S53.

In step S32, the display control unit 93 receives the proxy data transmitted from the reading unit 101, and the flow is advanced to step S33. In step S33, the display control unit 93 uses the received proxy data to display the optical disk 22A editing screen 180 in FIG. 9 on the picture monitor 44.

Specifically, the display control unit 93 creates a thumbnail picture data using the proxy data received from the reading unit 101, and displays the thumbnail picture 181A at the edit object display portion 181. Also, in the event the edit list file is selected at the edit list selection screen 160 in FIG. 7, the display control unit 93 reads the proxy data of the sub-clip corresponding to the edit list file thereof from the optical disk 21A, creates the thumbnail picture data corresponding to such sub-clip, and displays the thumbnail picture 182A at the edit result display portion 182. Further, the display control unit 93 displays a cursor 183, finalizing button 184, and finish button 185.

Following the processing in step S33, the flow is advanced to step S34, and the display control unit 93 determines whether the user has requested settings for the editing segment, i.e. whether the finalizing button 184 is operated at the optical disk 22A editing screen 180, according to the operating signals from the receiving unit 91, and in the even that determination is made that specification of the editing segment is requested, the flow is advanced to step S35.

In step S35, the display control unit 93 displays the clip pictures corresponding to a thumbnail picture 181A on an picture monitor 44 as the editing segment setting screen 200 in FIG. 10, based on such thumbnail picture 181A corresponding to the position of the cursor 183 when the finalizing button 184 is operated. Now, the user sets the editing segment by operating the remote controller 201.

Following the processing in step S35, the flow is advanced to step S36, and the recording control unit 92 determines whether or not the editing segment is set by the user according to the operating signal from the receiving unit 91, i.e. whether or not the finalizing button 214 of the remote controller 201 is operated, and in the event determination is made that the editing segment is not set, the flow stands by until the editing segment is set.

On the other hand, in the event that determination is made in step S36 that the editing segment is set by the user, the flow is advanced to step S37, wherein the recording control unit 92 creates and records a clip edit list based on the editing segment thereof.

Following the processing in step S37, the flow is advanced to step S38, wherein the recording control unit 92 transmits the clip edit list created in step S37, and the flow is advanced to step S39.

In step S53, the recording control unit 102 receives the clip edit list transmitted from the recording control unit 92, and the flow is advanced to step S54. In step S54, the recording control unit 102 correlates the clip edit list thereof to a clip file of a corresponding clip, and records this in the optical disk 22A.

Thus, a clip edit list is recorded in the optical disk 22A, so for example, in the case that the corresponding clip file is an edit object to be edited again, the reading unit 101 transmits the proxy data of the sub-clip based on the clip edit list to the recording control unit 92, thereby enabling the thumbnail picture of the sub-clip corresponding to the editing segment set beforehand to be displayed on the edit object display portion 181.

In step S39, the display control unit 93 displays the optical disk 22A display screen 200 in FIG. 11, based on the editing segment set by the user and the proxy data of the clip corresponding to the picture displayed as the editing segment setting screen 200 in step S35.

Specifically, the display control unit 93 creates thumbnail picture data of the picture data corresponding to the editing segment from the clip picture data, based on the editing segment determined by the user and the proxy data of the clip corresponding to the picture displayed as the editing segment setting screen 200. The display control unit 93 attaches the frame 221A to the thumbnail picture 221 corresponding to the thumbnail picture data, and displays this on the edit object display portion 182. Consequently, the optical disk 22A display screen 220 in FIG. 11, wherein the thumbnail picture 221 is added with the frame 221A attached to the edit object display portion 181 in FIG. 9, is displayed on the picture monitor 44.

In the event determination is made in step S34 that the setting of the edit segment is not requested, or following processing of the step S39, the flow advances to step S40, and the recording control unit 92 determines whether or not the playback sequence of the unprocessed data to be edited is specified by the user according to the operating signals from the receiving unit 91, i.e. whether or not the user has performed drag-and-drop at the optical disk 22A display screen 180 or 220, and the event determination is made that the playback sequence is specified, the flow is advanced to step S41.

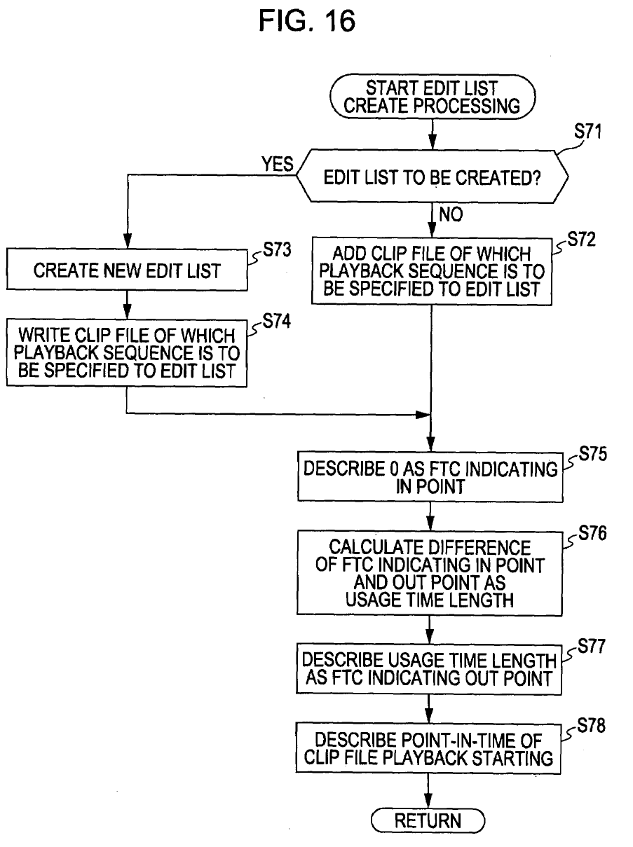

In step S41, the recording control unit 92 performs edit list create processing to created an edit list based on the playback sequence specified by the user. The details of the edit list create processing will be described later with reference to FIG. 16.

Following the processing in step S41, the flow is advanced to step S42, wherein the recording control unit 92 determines the FTC indicating the in point and out point of the unprocessed data serving as an edit object to be subjected to playback sequence specifying, as an FTC indicating the starting point of a sub-clip to be subjected to transmission request to the copy source processing unit 82 (hereafter called starting point FTC) and a FTC indicating the ending point thereof (hereafter called ending point FTC).

Specifically, in the case that the unprocessed data to be subjected to playback sequence specifying is the unprocessed data of the editing segment set by the user, the FTC indicating the in point and out point of such editing segment is determined to be the starting point FTC and ending point FTC, and in the event that unprocessed data is not that of the editing segment set by the user, i.e. in the event the unprocessed data to be subjected to playback sequence specifying is the clip itself, the FTC showing the leading position and the tail end position of the clip is determined to be the starting point FTC and ending point FTC.

In step S43, by transmitting the starting point FTC and ending point FTC, as well as the MPUMID of the clip file corresponding to the unprocessed data to be edited which is subjected to playback sequence specifying, the recording control unit 92 requests transmission of the sub-clip data made up of the sub-clip and the non-real-time metadata corresponding to the sub-clip thereof from the copy source processing unit 82, and the flow is advanced to step S44.

In step S55, the reading unit 101 receives a request transmitted from the recording control unit 92, and the flow is advanced to step S56. In step S56, the reading unit 101 reads the sub-clip data of which transmission is requested by the recording control unit 92 from the optical disk 22A, and transmits this as a file to the recording control unit 92.

Specifically, the reading unit 101 reads the unprocessed data from the starting point FTC to the ending point FTC of the clip file to which the MPUMID transmitted from the recording control unit 92 is attached, as a clip file, and also creates the non-real-time metadata corresponding to the sub-clip thereof. Also the reading unit 101 transmits sub-clip data made up of the sub-clip and the non-real-time metadata corresponding to the sub-clip thereof as a file to the recording control unit 92. Note that the file of the sub-clip data transmitted from the reading unit 101 is made up of the file of the sub-clip and the file of the non-real-time metadata, and the format for each file is the format shown in FIG. 5.

In step S44, the recording control unit 92 receives the file of the sub-clip data transmitted from the reading unit 101, and the flow is advanced to step S45. In step S45, the recording control unit 92 records the file of the sub-clip from the files of the received sub-clip data as a clip file on the optical disk 21A, and records the non-real-time metadata file as a metadata file.

Thus, upon the user performing drag-and-drop, the recording control unit 92 performs edit list create processing, and also copies the sub-clip from the optical disk 22A to the optical disk 21A. Accordingly, by the user performing the one operation called drag-and-drop, non-linear editing of the clip recorded on the optical disk 22A is performed, and the editing data of the editing results can be consolidated in the optical disk 21A. That is to say, the efficiency of the work in the case of consolidating the editing data to the optical disk 21A is good.

Also, as well as consolidating the editing data to the optical disk 21A, creating of the edit list is also performed, and therefore immediately following consolidating, the video editing device 23 can play back the edit results from the optical disk 21A according to the edit list.

Further, in step S45, the recording control unit 92 changes the MPUMID described in the edit list in step S72 or S74 (in FIG. 16 to be described later) within step S41 to an MPUMID included in the file header of the received sub-clip.

Following processing of the step S45, the flow is advanced to step S46, wherein the display control unit 93 determines whether or not ending the editing for the clip recorded in the optical 22A has been commanded by the user, i.e. whether or not the finish button 185 has been operated, and in the event that determination is made that ending is not commanded, the flow is returned to step S34, wherein the above-described processing is repeated.

On the other hand, in the event that determination is made in step S46 that ending the editing for the clip recorded in the optical disk 22A has been commanded by the user, the consolidating processing without margin is ended.

Next, the edit list creating processing in step S41 of FIG. 15 will be described in detail with reference to FIG. 16.

In step S71, the recording control unit 92 determines whether or not an edit list is created based on the operating signal from the receiving unit 91, i.e. whether or not the new button 165 is operated by the user at the edit list selection screen 160 shown in step S6 in FIG. 14.

In the event that determination is made in step S71 to not create the edit list, the flow is advanced to the step S72, wherein the recording control unit 92 adds the MPUMID, which is attached to the clip file of the clip corresponding to the unprocessed data to be edited which is subjected to playback sequence specifying, to the position of the par element of the edit list of the edit list file selected by the user corresponding to the playback sequence specified by the user.

On the other hand, in the case that determination is made in step S71 that the edit list is to be created, the flow is advanced to step S73, wherein the recording control unit 92 creates a new edit list which has nothing described to the par elements, and the flow is advanced to step S74.

In step S74, the recording control unit 92 describes the MPUMID attached to the clip file corresponding to the unprocessed data to be specified in the playback sequence, to the par element of the edit list created at step S73.

Following processing of step S72 or S74, the flow is advanced to step S75, wherein the recording control unit 92 describes 0 as the FTC showing the in point of a clip file, to an edit list wherein the MPUMID of such clip file corresponding to the unprocessed data to be edited which is subjected to playback sequence specifying is described. Specifically, following the MPUMID of the clip file described to the par elements of the edit list in FIG. 13, the recording control unit 92 describes “clipBegin=“smpte-30=00:00:00:00””.

Following the processing in step S75, the flow is advanced to step S76, wherein the recording control unit 92 calculates the difference of the FTC showing the in point and out point of the editing segment determined by the user at the editing segment setting screen 200 displayed in step S35 in FIG. 15, as usage time length. For example, For example, in the case that the FTC showing the in point of the editing segment determined by the user is “00:00:05:00” and the FTC showing the out point is “00:00:09:00”, the recording control unit 92 calculates the usage time length, as “00:00:04:00” which is “00:00:05:00” subtracted from “00:00:09:00”.

Following processing of step S76, the flow is advanced to step S77, wherein the recording control unit 92 describes usage time length as the FTC showing the out point of a clip file, to an edit list wherein the FTC, showing the in point and UMID of such clip file of the unprocessed data to be edited which is subjected to playback sequence specifying, is described. For example, in the case that the usage time length is “00:00:04:00”, following the “clipBegin=“smpte-30=00:00:00:00”” described in the par element of the edit list, the recording control unit 92 describes “clipEnd=“smpte-30=00:00:04:00”.

Following processing of step S77, the flow is advanced to step S78, wherein the value adding the point-in-time of playback starting of the clip file immediately prior to a clip file (hereafter called immediately prior clip file) to the time from the in point of the immediately prior clip file to the out point is described in the edit list wherein the FTC showing the UMID of the clip file of the unprocessed data subjected to playback sequence specifying, as well as the in point and out point, are described, as the point-in-time of playback starting of the clip file from the unprocessed data subjected to playback sequence specifying.

For example, as description of the immediately prior clip file, in the event that “clipBegin=“smpte-30=00:00:00:00””, “clipEnd=“smpte-30=00:00:06:00””, and “begin=“smpte-30=00:00:00:00”” are sequentially described, the recording control unit 92 describes “begin=“smpte-30=00:00:06:00”” as the point-in-time of the playback of the clip file from the unprocessed data subjected to playback sequence specifying.

Following the processing of step S78, the flow is returned to step S41 in FIG. 15, and the processing in step S42 in FIG. 15 is performed.

Next, the consolidating processing with margin with the consolidating unit 80 will be described with reference to FIG. 17.

The processing in steps S91 through S101 are the same as the processing in steps S31 through S41 in FIG. 15, so the description thereof will be omitted. Also, the processing in steps S111 through S114 are the same as the processing in steps S51 through S54 in FIG. 15, so the description thereof will be omitted.

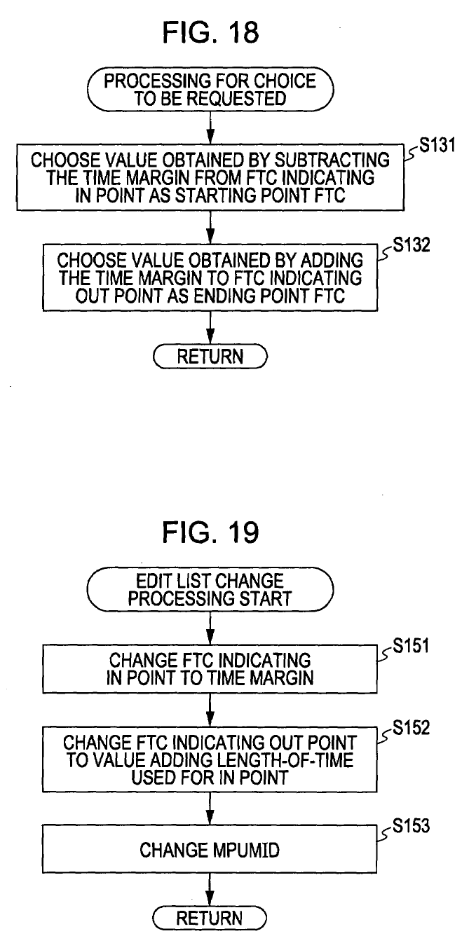

In step S102, the recording control unit 92 performs request object decision processing which determines the object of transmission request to the copy source processing unit 82. The details of the request object determining processing of the request object determining processing will be described later with reference to FIG. 18.

Following the processing in step S102, the flow is advanced to step S103, wherein the recording control unit 92 transmits the starting FTC and ending FTC determined in step S102, as well as the MPUMID of the clip file corresponding to the unprocessed data subjected to playback sequence specifying, to the copy source processing unit 82, thus requesting transmission of the sub-clip wherein margin data is attached to the copy source processing unit 82 and the attached sub-clip data made up of non-real-time metadata corresponding thereto.

In step S115, the reading unit 101 receives a request transmitted from the recording control unit 92, similar to the processing in step S55 in FIG. 15, and the flow is advanced to step S116. In step S116, the reading unit 101 reads the attached sub-clip data of which transmission is requested by the recording control unit 92 from the optical disk 22A, transmits this to the copy destination processing unit 81 as a file, and ends the processing.

Following the processing in step S103, the flow is advanced to step S104, wherein the recording control unit 92 receives the file of the attached sub-clip data transmitted from the reading unit 101 in step S116. Following the processing in step S104, the flow is advanced to step S105, wherein the recording control unit 92 records the file of the sub-clip to which margin data is attached from the files of the received attached sub-clip data, on the optical disk 21A as a clip file, and also records the files of the non-real-time metadata as a metadata file.

In step S106, the recording control unit 92 performs edit list changing processing for changing the edit list created in step S101. The details of the edit list changing processing will be described later in FIG. 19.

Following the processing in step S106, the flow is advanced to step S107, wherein, in the same way as with step S46 in FIG. 15, the display control unit 93 determines whether or not the user has commanded ending the editing of the clip recorded in the optical disk 22A, and in the event it is determined that ending is not commanded, the flow is returned to step S94, and the above-described processing is repeated.

On the other hand, in the event that it is determined the user has not commanded ending the editing of the clip recorded in the optical disk 22A in step S106, the consolidating processing with margin is ended.

Next, the request object determining processing in step S102 in FIG. 17 will be described with reference to FIG. 18.

In step S131, the recording control unit 92 determines the value wherein margin time is subtracted from the FTC showing the in point of the unprocessed data to be edited which is subjected to playback sequencing processing, as the starting point FTC, and the flow is advanced to step S132.

In step S132, the recording control unit 92 determines the value wherein margin time is added to the FTC showing the out point of the unprocessed data to be edited which is subjected to playback sequencing processing, as the ending point FTC, and the flow is returned to step S102 in FIG. 17, and advanced to step S103.

Next, the edit list changing processing in step S106 in FIG. 17 will be described with reference to FIG. 19.

In step S151, the recording control unit 92 changes the FTC showing the in point of the clip file of the unprocessed data which is subjected to playback sequence specifying, which is described in the edit list created or updated in step S101 in FIG. 17, to margin time. For example, in the case that margin time is five seconds, the recording control unit 92 changes the description of “clipBegin=“smpte-30=00:00:00:00”” of the clip file of unprocessed data which is subjected to playback sequence specifying, to “clipBegin=“smpte-30=00:00:05:00””.

Following the processing in step S151, the flow is advanced to step S152, wherein the recording control unit 92 changes the FTC showing the out point of the clip file of the unprocessed data which is subjected to playback sequence specifying, which is described in the edit list created or updated in step S101 in FIG. 17, to a value wherein the usage time length calculated in step S76 in FIG. 16 is added to the in point changed in step S151. For example, in the event that the usage time length is four seconds, and is changed to “clipBegin=“smpte-30=00:00:05:00”” in step S151, the recording control unit 92 changes the description showing the FTC of the out point of the clip file of the unprocessed data subjected to playback sequence specifying to “clipEnd=“smpte-30=00:00:09:00””.

Following the processing in step S152, the flow is advanced to step S153, wherein the recording control unit 92 changes the MPUMID described in the edit list in step S72 or S74 in FIG. 16, to an MPUMID included in the header of the file of the attached sub-clip data received in step S104 in FIG. 17. Following the processing in step S153, the flow is returned to step S106 in FIG. 17, and the processing in step S107 is performed.

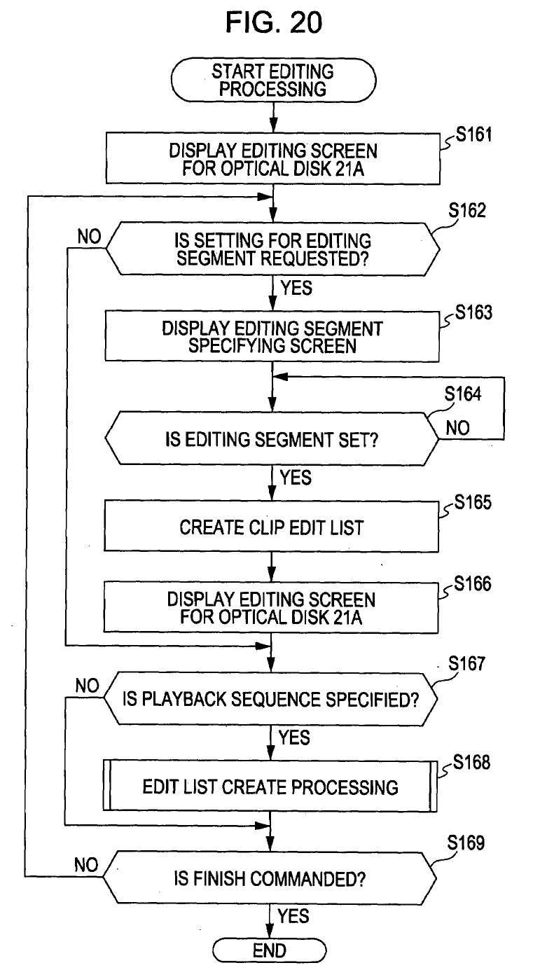

Next, the editing processing performed by the consolidating unit 80 in the case that the user commands editing of the clips recorded in the optical disk 21A will be described with reference to FIG. 20.

In step S161, the display control unit 93 reads the proxy data corresponding to the clip files recorded in the optical disk 21A from the clip files whereof selection has been determined in step S5 in FIG. 14, from the optical disk 21A, and displays the optical disk 21A editing screen on the picture monitor 44.

Specifically, the display control unit 93 creates the thumbnail picture data using proxy data read from the optical disk 21A, and displays the thumbnail picture at the edit object display portion. Also, in the case that an edit list file is selected at the edit list selection screen 160 in FIG. 7, the display control unit 93 reads the proxy data of the sub-clip corresponding to the edit list file from the optical disk 21A, creates the thumbnail picture data corresponding to the sub-clip thereof, and displays the thumbnail picture at the editing result display portion. Further, the display control unit 93 displays a cursor, finalizing button, and finish button.

Following the processing in step S161, the flow is advanced to step S162, wherein the display control unit 93 determines whether or not the user has requested setting of the edit segment according to the operating signals from the receiving unit 91, and in the case that determination is made that specification of the edit segment is requested, the flow is advanced to step S163.

In step S163, the display control unit 93 displays the picture of a clip corresponding to a thumbnail picture, based on such thumbnail picture corresponding to the cursor position when the finalizing button is operated, on the picture monitor 44, as the edit segment setting screen 200 in FIG. 10.

Following the processing in step S163, the flow is advanced to step S164, wherein the recording control unit 92 determines whether or not the user has set the editing segment according to the operating signals from the receiving unit 91, and in the case that determination is made that the editing segment is not set, the flow stands by until the editing segment is set.

On the other hand, in the case that determination is made in step S164 that the user has set the editing segment, the flow is advanced to step S165, wherein the recording control unit 92 creates and records a clip edit list based on the editing segment thereof.

Following the processing in step S165, the flow is advanced to step S166, wherein the display control unit 93 displays the optical disk 21A editing screen based on the editing segment set by the user and the proxy data of the clip corresponding to the picture displayed in step S163 as the editing segment setting screen 200.

Specifically, the display control unit 93 creates thumbnail picture data of picture data corresponding to the editing segment from the clip picture data, based on the editing segment chosen by the user and the proxy data of the clip corresponding to the picture displayed as the editing segment setting screen 200. The display control unit 93 then attaches a frame to the thumbnail picture corresponding to the thumbnail picture data thereof and displays this at the edit object display portion.

In the event that determination is made in step S162 that setting of the editing segment is not requested, or following processing of the step S166, the flow is advanced to step S167, wherein the recording control unit 92 determines whether or not the user has specified the playback sequence of the unprocessed data to be edited, according to the operating signals from the receiving unit 91, i.e. whether or not the user has performed drag-and-drop, and in the event that determination is made that the playback sequence is specified, the flow is advanced to step S168.

In step S168, the recording control unit 92 performs similar processing as the edit list create processing in FIG. 16. Following processing of step S168, the flow advances to step S169, wherein the recording control unit 93 determines whether or not the user has commanded ending the editing of the clips recorded on the optical disk 21A, and in the event that determination is made that ending is not commanded, the flow returns to step S162, and repeats the above-described processing.

On the other hand, in the event that determination is made that the user has commanded ending the editing of the clip recording in the optical disk 21A, the editing processing is ended.

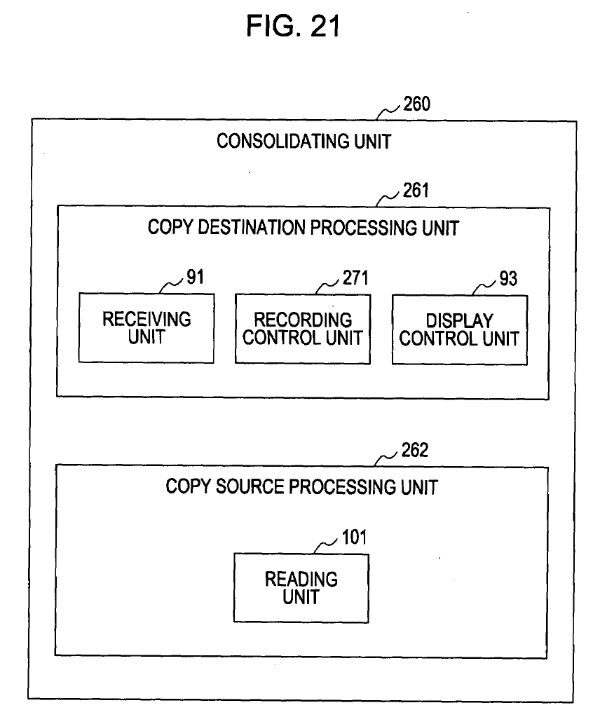

Note that with the description made with reference to FIGS. 15 through 19 above, the clip edit list is described as being arranged to be recorded on the optical disk 22A; however, recording does not necessarily have to be performed. A functional configuration example of the consolidating unit in this case is shown in FIG. 21.

In the consolidating unit 260 in FIG. 21 comprises a copy destination processing unit 261 and a copy source processing unit 262. Note that in FIG. 21, reference numerals are the same for the same items in FIG. 3, and the description thereof will be repetitive and so will be omitted.

The copy destination processing unit 261 comprises a receiving unit 91, display control unit 93, and recording control unit 271.

The recording control unit 271 performs editing of the clips recorded in the optical disks 21A and 22A according to the operating signals from the receiving unit 91 and also consolidates the editing data to the optical disk 21A.

Specifically, the recording control unit 271 creates an edit list according to the operating signals from the receiving unit 91, as with the recording control unit 92 in FIG. 3, and records this on the optical disk 21A. Also, the recording control unit 271 requests the sub-clip from the unprocessed data recorded in the optical disk 22A or the sub-clip to which margin data is added, according to the operating signals from the receiving unit 91, similar to the recording control unit 92 in FIG. 3, to the reading unit 101 of the copy source processing unit 262, and records the sub-clip or the sub-clip to which margin data is added, which is transmitted according to the request thereof, to the optical disk 21A.

The copy source processing unit 262 is configured with the reading unit 101. That is to say, the copy source processing unit 261 is configured as the copy source processing unit 82 in FIG. 3 with the recording control unit 102 removed therefrom.

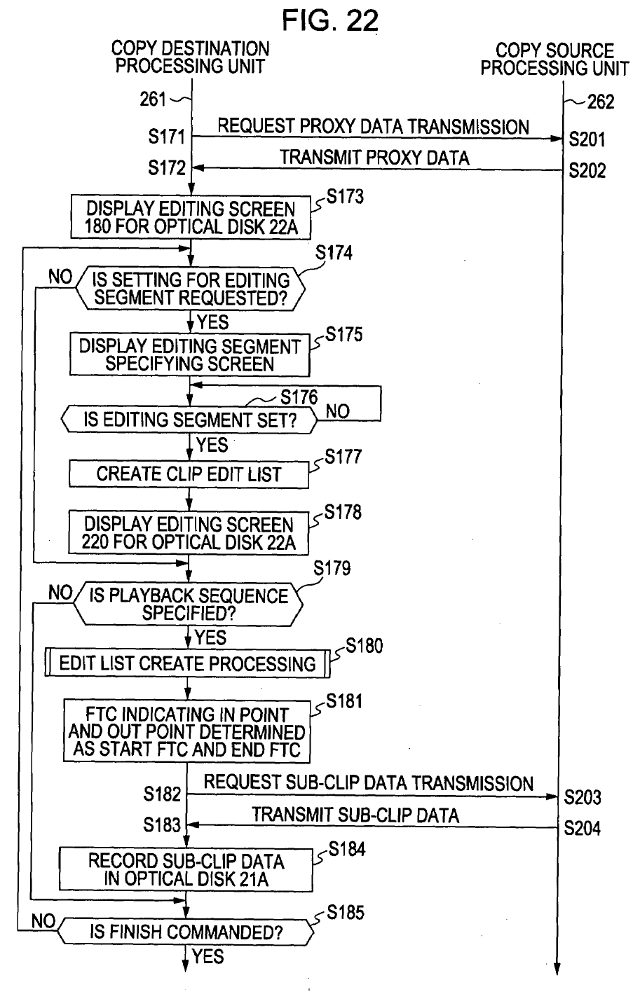

Next, the consolidating processing without margin by the consolidating unit 260 will be described with reference to FIG. 22.

The consolidating process without margin is a process wherein the processing steps S38 and S53 serving as processing for transmitting and receiving of the clip edit list from the consolidating processing without margin in FIG. 15, as well as the processing in step S54 serving as recording process of the clip edit list, have been omitted.

That is to say, the processing in steps S171 through S185 is the same as the processing in steps S31 through S37 and steps S39 through S46 in FIG. 15, and the processing in steps S201 through S204 is the same as the processing in steps S51 and S52, as well as steps S55 and S56 in FIG. 15.

Note that although description will be omitted, the consolidating processing with margin with the consolidating unit 260 is a process wherein the processing steps S98 and S113 serving as processing for transmitting and receiving of the clip edit list from the consolidating processing with margin in FIG. 17, as well as the processing in step S114 serving as recording process of the clip edit list, have been omitted.

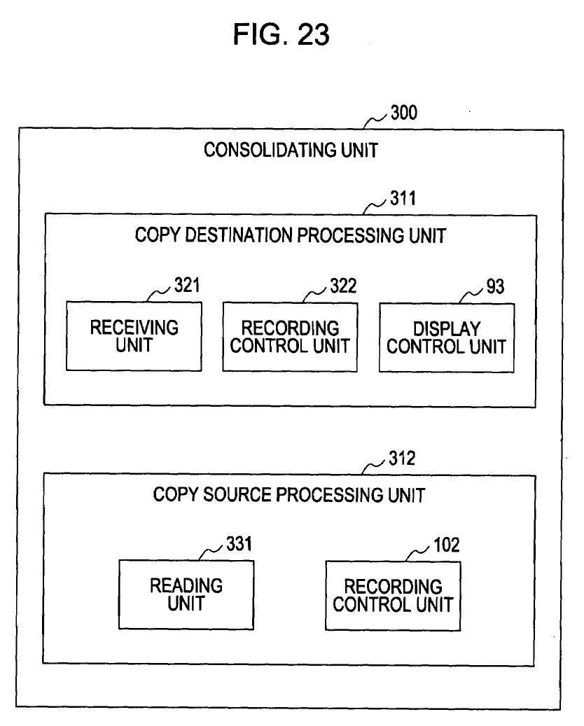

With the above description, the user performs an operation to set the margin time with the margin setting screen 170 prior to consolidating the editing data to the optical disk 21A, but an arrangement may be made wherein the user performs an operation to set the margin time after the consolidation of editing data, and adding the margin data to the optical disk 21A. A functional configuration example of the consolidating unit in this case is shown in FIG. 23.

A consolidating unit 300 in FIG. 23 comprises a copy destination processing unit 311 and a copy source processing unit 312. Note that in FIG. 23, the same items as in FIG. 3 have the same reference numerals, and description thereof will be repetitive so will be omitted.

The copy destination processing unit 311 comprises a display control unit 93, receiving unit 321, and recording control unit 322.

The receiving unit 321 receives an operating signal corresponding to the operation for performing a command relating to the editing supplied from the operating unit interface 56 in FIG. 2. Also, the receiving unit 321 receives an operating signal corresponding to the operation for performing a command relating to adding the margin data supplied from the operating unit interface 56. The receiving unit 321 supplies the operating signal to the display control unit 93 or the recording control unit 322.

The recording control unit 322 performs non-linear editing of the clips recorded in the optical disks 21A and 22A, according to the operating signals for the receiving unit 321, and consolidates the editing data of the editing results in the optical disk 21A.

Specifically, similar to the recording control unit 92 in FIG. 3, the recording control unit 322 creates an edit list of the clips recorded in the optical disks 21A and 22A according to the operating signal from the receiving unit 321, and records this on the optical disk 21A.

Also, as with the recording control unit 92 in FIG. 3, the recording control unit 322 creates a clip edit list according to the operating signals from the receiving unit 321, and transmits this to the recording control unit 102 of the copy source processing unit 312. Further, the recording control unit 322 requests a sub-clip form the unprocessed data recorded in the optical disk 22A to the reading unit 331 of the copy source processing unit 312 according to the operating signals from the receiving unit 321, and records the sub-clips transmitted according to the request thereof on the optical disk 21A.

Also, the recording control unit 322 requests the margin data from the unprocessed data recorded on the optical disk 22A from the reading unit 331 according to the operating signal from the receiving unit 321, and adds the margin data transmitted according to the request thereof to the sub-clip of the optical disk 21A. Note that the margin data only needs to be logically added to the sub-clip, and the margin data and the sub-clip added to the margin data can be separated regarding physical disposal on the optical disk 21A.

The copy source processing unit 312 comprises the recording control unit 102 and reading unit 331. The reading unit 331 reads the sub-clip or margin data from the optical disk 22A according to requests from the recording control unit 322, and supplies this to the recording control unit 92. Also, the reading unit 331 reads the proxy data from the optical disk 22A according to the request from the display control unit 93, as with the reading unit 101 in FIG. 3, and supplies this to the display control unit 93.

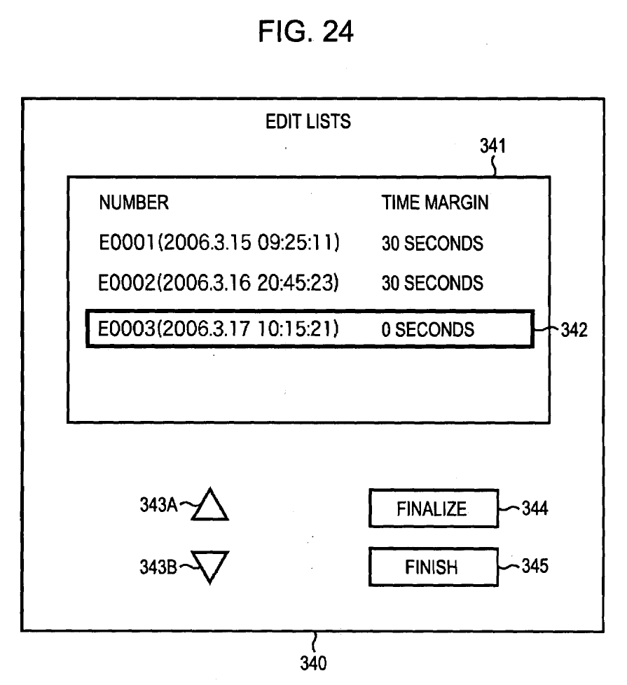

Next, FIG. 24 shows an example of the margin changing screen 340 for changing the margin time which is displayed by the display control unit 93.

The margin changing screen 340 in FIG. 24 comprises a time setting unit 341, cursor 342, upper direction button 343A, lower direction button 343B, finalizing button 344, and finish button 345.

The create date/time and name of the edit list file in the optical disk 21A serving as the copy destination, and the margin time set as to the edit list, are displayed at a time setting portion 341.

With the example in FIG. 24, the directory configuration of the file recorded on the optical disk 21A is the directory configuration shown in FIG. 4, wherein following the first five characters of the name of the first through third edit list files, the create date/time of each of the first through third edit list files are displayed in parentheses.

Also, thirty seconds is displayed as the margin time corresponding to the create date/time and name of the first and second edit list files, and zero seconds is displayed as the margin time corresponding to the create date/time and name of the third edit list file. That is to say, the sub-clips corresponding to the first and second edit list files already have thirty seconds worth of margin data attached thereto, before and after, but the sub-clip corresponding to the third edit list file has no margin data attached thereto.

The cursor 342 is displayed in a position corresponding to the name and created date and time of the edit list file displayed in the time setting portion 341, as well as margin time. The cursor 342 is operated when the user sets the margin time as to the desired edit list, and is moved to the position corresponding to the desired edit list of the user. Note that the margin time is not set as to the edit list to which margin data is already attached to the sub-clips. Accordingly, the cursor 342 is arranged so as not to be moved to positions corresponding to the first and second edit list files.

The upper direction button 343A is operated when moving the cursor 342 in the upper direction, and the lower direction button 343B is operated when moving the cursor 342 in the lower direction. The finalizing button 344 is operated when changing the margin time as to the edit list corresponding to the current position of the cursor 342. The finish button 345 is operated when ending the display of the margin changing screen 340.

The user moves the cursor 342 to a position corresponding to the desired edit list by operating the upper direction button 343A or the lower direction button 343B at the margin changing screen 340 in FIG. 24 and operates the finalizing button 344. Thus, the margin changing screen 340 in FIG. 24 is changed to the margin setting screen 170 in FIG. 8, wherein the user chooses the margin time at the margin setting screen 170 as described above.

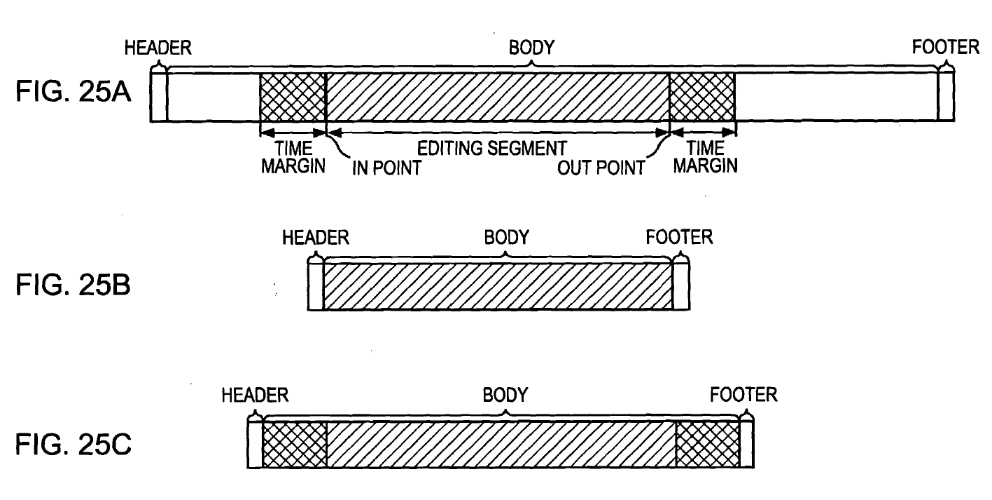

Next, adding margin data with the recording control unit 322 shown in FIG. 23 will be described with reference to FIGS. 25A through 25C.

FIG. 25A shows an example of a clip file of a clip to be edited, which is recorded in the optical disk 22A. Note that the format of the clip file is the format shown in FIG. 5.

Upon the in point and out point as well as the playback sequence being specified by the user as to the clip in the clip file in FIG. 25A, the data of the editing segment from the in point to the out point of the clip is copied from the optical disk 22A to the optical disk 21A, as a clip file of a sub-clip.

Note that the format for the clip file of the sub-clip in FIG. 25B is similar to the format shown in FIG. 5, but the FPUMID described in the header metadata is arranged as a partially processed MPUMID of the clip file which is the base for the clip file of this sub-clip, i.e. the clip file of the clip to be edited. Accordingly, by referencing the FPUMID of the header of the clip file of the sub-clip, the recording control unit 322 can recognize the MPUMID of the clip file which is the base for the clip file thereof.

With the margin changing screen 340 in FIG. 24, upon the margin time being set as to the edit list which includes description relating to the clip file of the sub-clip shown in FIG. 25B, the recording control unit 322 recognizes the MPUMID of the clip file which is the base, from the FPUMID of such clip file, supplies the MPUMID and margin time to the reading unit 331, and requests transmission of the margin data to the reading unit 331.

The reading unit 331 reads the clip file which is the base for the clip file of the sub-clip, which is recorded in the optical disk 22A, based on the MPUMID supplied from the recording control unit 322, and transmits margin time before and after the sub-clip from the clip of the clip file worth of unprocessed data to the recording control unit 322 as margin data. As FIG. 25C shows, the recording control unit 322 adds the margin data received from the reading unit 331 before and after the body of the clip file of the sub-clip.

Note that an arrangement may be made wherein the reading unit 331 creates non-real-time metadata corresponding to the margin data, and transmits such non-real-time metadata along with the margin data to the recording control unit 322. In this case, the recording control unit 322 adds the non-real-time metadata to the metadata file of the sub-clip.

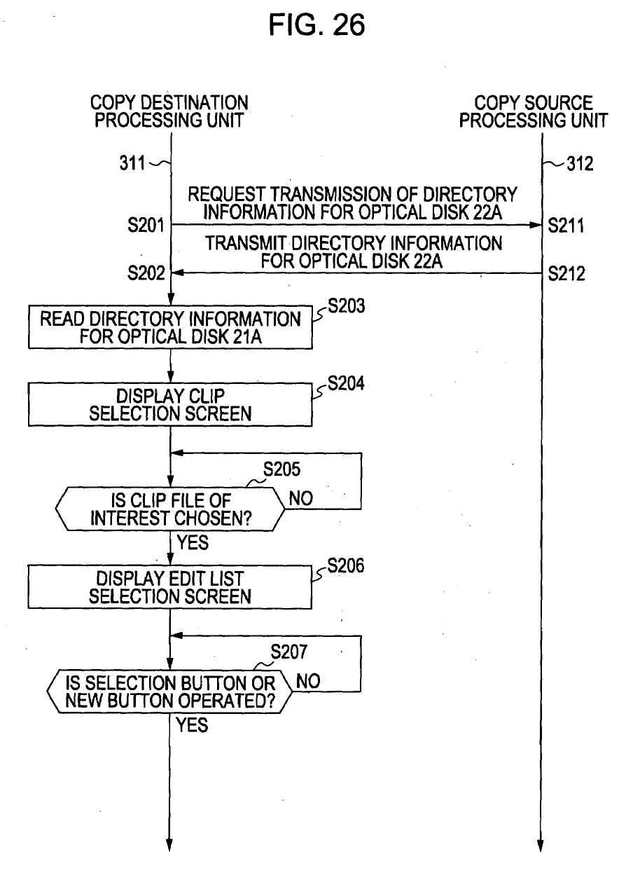

Next, the pre-consolidating processing which the consolidating unit 300 shown in FIG. 23 performs before consolidating the editing data will be described with reference to FIG. 26. The pre-consolidating processing is started when the user commands the start of video editing by operating the operating unit 42, for example.

The pre-consolidating processing in FIG. 26 has the processing in step S8 of the pre-consolidating processing in FIG. 14 removed therefrom. That is to say, the processing in steps S201 through S207 in FIG. 26 is similar to the processing in steps S1 through S7 in FIG. 14, and the processing in steps S211 and 212 in FIG. 26 is the same as the processing in steps S11 and S12 in FIG. 14.

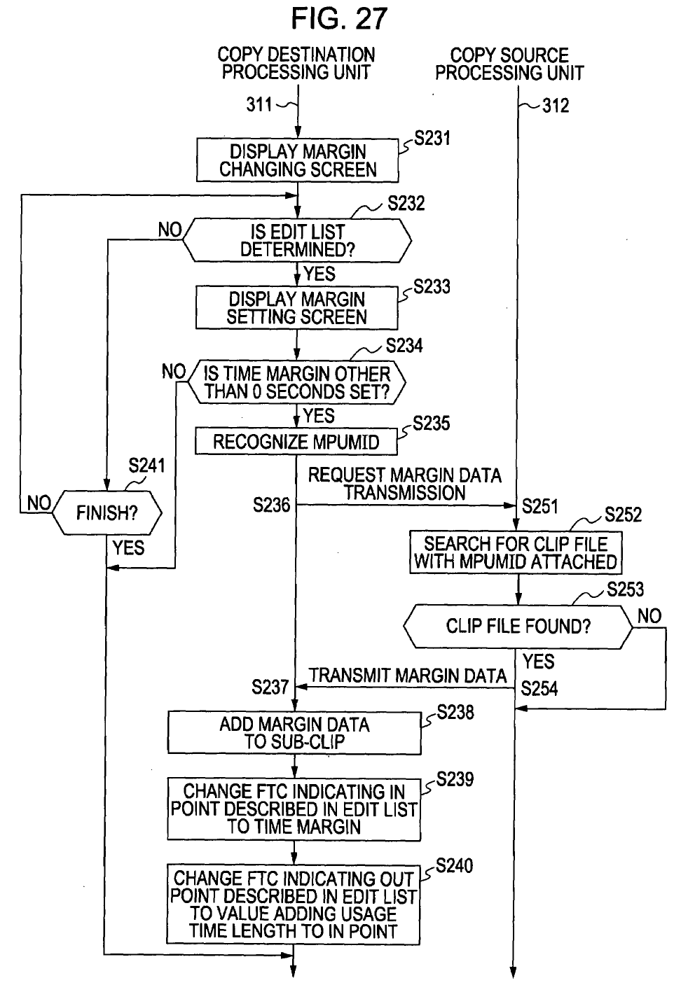

Following the pre-consolidating processing in FIG. 26, the consolidating unit 300 performs the consolidating processing without margin as shown in FIG. 15, and consolidates the editing data to the optical disk 21A. After this, upon the user commanding display of the margin changing screen 340 in FIG. 24 as one of the commands relating to adding margin data, for example, the consolidating unit 300 performs adding processing to add the margin data shown in FIG. 27.

In step S231 in FIG. 27, the display control unit 93 of the copy destination processing unit 311 displays the margin changing screen 340 according to the operating signals corresponding to the command displayed at the margin changing screen 340 from the receiving unit 321.

In step S232, the receiving unit 91 determines whether or not the edit list which changes the margin time has been determined, i.e. whether or not the finalizing button 344 has been operated at the margin changing screen 340 in FIG. 24, and in the event it is determined that the edit list for changing the margin time has been chosen, the flow is advanced to step S233.

In step S233, the display control unit 93 displays the margin setting screen 170 in FIG. 8, and the flow is advanced to step S234. In step S234, the receiving unit 91 determines whether or not a margin time other than 0 seconds is set, and in the event determination is made that a margin time other than 0 seconds has not been set, the processing is ended.

On the other hand, and in the event determination is made in step S234 that a margin time other than 0 seconds has been set, the flow is advanced to step S235, wherein the recording control unit 322 recognizes the MPUMID for the clip file which is the base of a clip file, based on the FUPMID described in the header metadata of such clip file of the sub-clip referenced in the edit list wherein margin time is set.

Following the processing in step S235, the flow is advanced to step S236, wherein the recording control unit 322 supplies the MPUMID recognized in step S235 and the margin time to the reading unit 331 of the copy source processing unit 312, and requests transmission of the margin data from the reading unit 331.

In step S251, the recording control unit 322 receives the request transmitted in step S236, and the flow is advanced to step S252.

In step S252, the reading unit 331 searches the optical disk 22A for the clip file to which the MPUMID is attached, based on the MPUMID from the recording control unit 322, and the flow is advanced to step S253.

In step S253, the reading unit 331 determines whether or not the clip file to which MPUMID supplied from the recording control unit 322 is attached has been found on the optical disk 22A, and in the event it is determined that the clip file has been found, the flow is advanced to step S254.

In step S254, the reading unit 331 reads out the data amount of the margin time before and after the editing segment, from the margin time supplied from the recording control unit 322 and the searched clip file based on the clip edit list recorded in step S54 in FIG. 15, takes this as margin data, transmits this to the recording control unit 322, and ends the processing.

On the other hand, in the event that determination is made in step S253 that the clip file has not been found, the processing is ended.

In step S237, the recording control unit 322 receives the margin data transmitted from the reading unit 331 in step S254, and the flow is advanced to step S238. In step S238, the recording control unit 322 adds the margin data received from the reading unit 331 to the sub-clip disposed in the body portion of the clip file of the sub-clip corresponding to the edit list wherein margin time is set. Consequently, as shown in FIG. 25C, a clip file is created wherein the sub-clip to which margin data is attached to the body portion thereof is disposed.

Following the processing in step S238, the flow is advanced to step S239, wherein the recording control unit 322 changes the FTC showing the in point of the clip file of the sub-clip to which margin data described in the edit list is attached, to margin time, and the flow is advanced to step S240.

In step S240, the recording control unit 322 changes the FTC showing the out point of the clip file of the sub-clip to which margin data described in the edit list is attached, to a value of the in point changed in step S239 to the usage time length calculated in step S76 in FIG. 16, and the process is ended.

On the other hand, in the event determination is made that the edit list for changing the margin time is not selected, the flow is advanced to step S241, wherein the receiving unit 91 determines whether or not the display of margin changing screen 340 is to be ended, i.e., whether or not the user has operated the finish button 345.

In the event that determination is made in step S241 to not end the display of the margin changing screen 340, the process is returned to step S232, and the flow stands by until the edit list for changing the margin time is set, or until the finish button 345 is operated.

Also, in the event that determination is made in step S241 to end the display of the margin changing screen 340, the process is ended.

Note that with the above-described FIGS. 23 through 27, the FPUMID of the clip file of the sub-clip is arranged as a processed MPUMID of the base clip file for the clip file of this sub-clip, but in the case that the FPUMID is attached irrespective of the MPUMID of the base clip file, an arrangement may be made wherein the MPUMID of the base clip file is described in the edit list file. An example of the edit list in this case is shown in FIG. 28.

In the event that the file to be referenced is the clip file of a sub-clip created with the clip file recorded on the optical disk 22A as a base, content described in the ref element in FIG. 13 as well as the MPUMID of the base clip file of the file to be referenced is described in the ref element of the edit list in FIG. 28.

That is to say, of the ref elements in rows 7 through 9 in FIG. 28, the description in row 7 is the same as the description in row 7 in FIG. 13, wherein the MPUMID assigned to the file to be referenced is shown. The description of “origin=“urn:smpte:umid:060A2B340101010501010D431300000070D30200009350597080046020118F593”” in row 8 shows that the file to be referenced is the clip file of the sub-clip, and that the MPUMID of the base clip file of such clip file is “060A2B340101010501010D431300000070D3020009350597080046020118F593”. Also, the description in row 9 is the same as the description in row 8 in FIG. 13.

Also, with the second clip also, description of rows 11 through 13 is made the same as in the case of the first clip.

Thus, with the edit list in FIG. 28, in the event of recording the corresponding sub-clip to the optical disk 21A as a clip file of the sub-clip, the MPUMID of the base clip file is recorded along with the MPUMID of the clip file of such sub-clip.

Note that also in the event that the MPUMID is described in the edit list, similar to the case wherein the FPUMID described in the header of the clip file of the sub-clip is arranged as a processed MPUMID of the base clip file, the consolidating unit 300 performs the pre-consolidating processing in FIG. 26, the consolidating processing without margin in FIG. 15, and the adding processing in FIG. 27.

However, in step S45 of FIG. 15, the recording control unit 322 describes the MPUMID attached to the clip file of the unprocessed data to be edited which is to be subjected to playback sequence specifying, along with the MPUMID described in steps S72 or S74 in FIG. 16, in the edit list. Also, in step S235 in FIG. 27, the recording control unit 322 recognizes the MPUMID of the base clip file of the clip file of the sub-clip, from the description content of the edit list wherein margin time has been set.

Further, with the above-described FIGS. 23 through 28, the edit list wherein margin data is already attached to the sub-clip is arranged such that margin time is not set, but may be arranged to enable setting a new margin time is the time is greater than the margin time of the margin data already attached to the sub-clip. In this case, in step S234, the receiving unit 91 determines whether or not the margin time is greater than the margin time before changing.

Also, with the description as above, an arrangement is made wherein the clips recorded in the optical disks 21A and 22A are to be edited, but an arrangement may be made wherein the sub-clips corresponding to the edit list recorded in the optical disks 21A and 22A are to be edited.

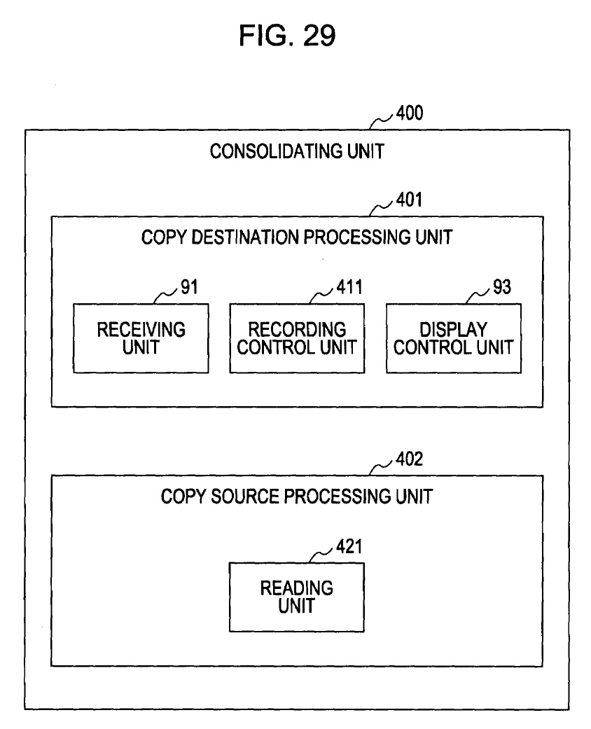

A functional configuration example of the consolidating unit in this case is shown in FIG. 29.

A consolidating unit 400 in FIG. 29 includes a copy destination processing unit 401 and a copy source processing unit 402. Note that in FIG. 29, items which are the same as those in FIG. 3 have the same reference numerals, and description thereof will be repetitive so will be omitted.

The copy destination processing unit 401 comprises a receiving unit 91, display control unit 93, and recording control unit 411.

The recording control unit 411 performs non-linear editing of the sub-clips corresponding to the edit list recorded in the optical disks 21A and 22A according to the operating signals from the receiving unit 91, and also consolidates the editing data from the editing results into the optical disk 21A. Specifically, the recording control unit 411 requests transmission of the edit list corresponding to the sub-clip to be edited, which is recorded in the optical disk 22A, from a reading unit 421 of the copy source processing unit 402, according to operating signals from the receiving unit 91, and receives the edit list transmitted from the reading unit 421 according to the request thereof. The recording control unit 411 creates a new edit list based on operating signals from the receiving unit 91 and the edit list recorded on the optical disks 21A and 22A, records this on the optical disk 21A.

Also, as with the recording control unit 92 in FIG. 3, the recording control unit 411 requests the sub-clip from the unprocessed data recorded on the optical disk 22A or the sub-clip to which margin data is attached, based on operating signals from the receiving unit 91, from the reading unit 421, and records the sub-clip transmitted according to the request thereof or the sub-clip to which margin data is attached, on the optical disk 21A.

The copy source processing unit 402 comprises a reading unit 421. The reading unit 421 reads an edit list from the optical disk 22A according to a request from the recording control unit 411, and supplies this to the recording control unit 411. Also, as with the reading unit 101 in FIG. 3, the reading unit 421 reads a sup-clip from the optical disk 22A according to a request from the recording control unit 411, or a sub-clip to which margin data is attached, and supplies this to the recording control unit 411. Further, the reading unit 421 reads proxy data from the optical disk 22A according to a request from the display control unit 93, similar to the reading unit 101, and supplies this to the display control unit 93.

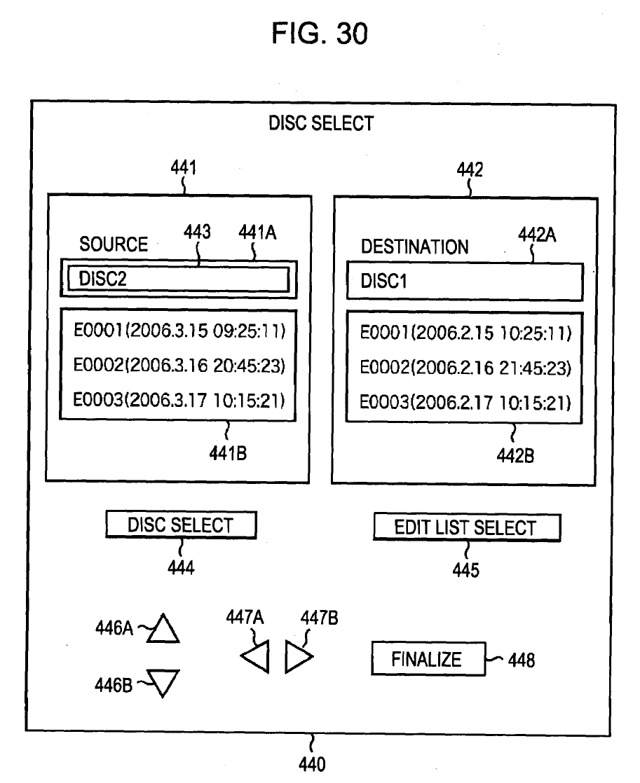

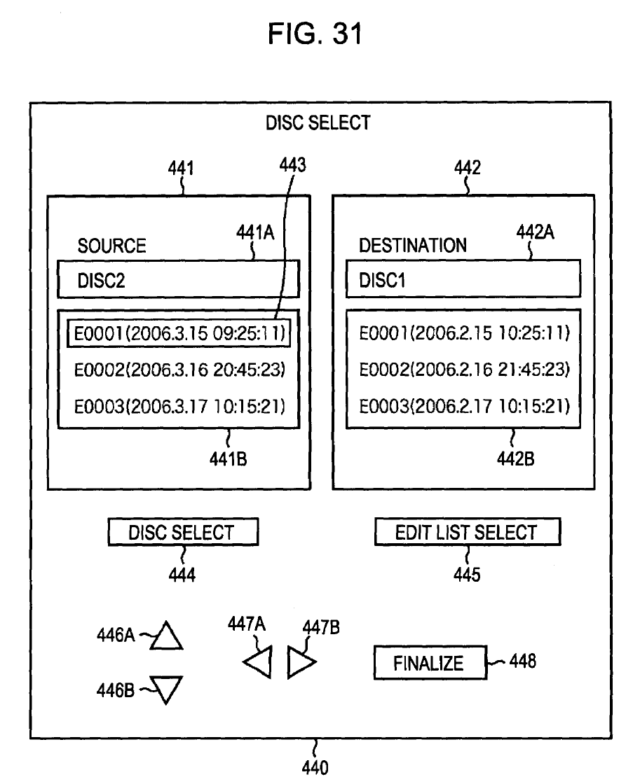

FIGS. 30 through 32 show an example of an editing screen displayed by the display control unit 93 in FIG. 29.

First, upon the user commanding the start of video editing, an edit object selection screen 440 in FIG. 30 or 31 which is one of the editing screens is displayed on the picture monitor 44. The edit object selection screen 440 in FIGS. 30 and 31 comprise a copy source display portion 441, copy destination display portion 442, cursor 443, disk selection mode button 444, edit list selection mode button 445, upper direction button 446A and lower direction button 446B, left direction button 447A and right direction button 447B, and finalizing button 448.

The copy source display portion 441 comprises a disk name display portion 441A wherein the name of the optical selected as the copy source is displayed, and an edit list display portion 441B, wherein the name and create date/time of the edit list file recorded on the optical disk selected as the copy source, are displayed.

Now, since the disk 22A is the copy source of the editing data, so the optical disk 22A is selected as the copy source, and the name of the optical disk 22A “DISC2” is displayed at the disk name display portion 441A. Also, with the example in FIGS. 30 and 31, the directory configuration of the files recorded in the optical disk 22A is the same directory configuration as that shown in FIG. 4, such that the first five characters of the name of the first through third edit list file names, followed by the create date/time of the first through third edit list files, in parentheses, are displayed at the edit list display portion 441B.

As with the copy source display portion 441, the copy destination display portion 442 comprises a disk name display portion 442A wherein the name of the optical disk selected as the copy destination is displayed, and an edit list display portion 442B, wherein the name and create date/time of the edit list file recorded on the optical disk selected as the copy destination, are displayed.

Now, since the disk 21A is the copy destination of the editing data, so the optical disk 21A is selected as the copy destination, and the name of the optical disk 21A “DISC1” is displayed at the disk name display portion 442A. Also, with the example in FIGS. 30 and 31, the directory configuration of the optical disk 21A is the same directory configuration as that shown in FIG. 4, such that the first five characters of the name of the first through third edit list file names, followed by the create date/time of the first through third edit list files, in parentheses, are displayed at the edit list display portion 442B.

In the event that the selection mode is a disk mode serving as a mode for selecting the optical disk as the copy destination or copy source, the cursor 443 is displayed in a position corresponding to the disk name display portion 441A or 442A.

On the other hand, if the selection mode is an edit list mode for selecting a desired edit list file, the cursor 443 is displayed in a position corresponding to the name and create date/time of the edit list file displayed at the edit list display portion 442A or 442B, and is moved to a position corresponding to the desired edit list file.

The disk selection mode button 444 is operated when setting the selection mode as disk mode. The edit list selection mode button 445 is operated when setting the selection mode as edit list mode.

In the case that the selection mode is in disk mode, the upper direction button 446A and lower direction button 446B are operated when changing the disk name corresponding to the cursor 443 displayed at the disk display portions 441A or 442A. For example, in the event that the selection mode is in disk mode, upon the user operating the upper direction button 446A or lower direction button 446B, the name of one of the optical disks 21A or 22A mounted on the video editing device 23, displayed at the disk display portion 441A or 442A is switched to the other name.

On the other hand, in the event the selection mode is in edit list mode, the upper direction button 446A is operated when moving the cursor 443 in the upper direction, and the lower direction button 446B is operated when moving the cursor 443 in the lower direction.

Regardless of mode, the left direction button 447A is operated when moving the cursor 443 in the left direction. Regardless of mode, the right direction button 447B is operated when moving the cursor 443 in the right direction.

In the case that the selection mode is in disk mode, the finalizing button 448 is operated when finalizing the disk corresponding to the position of the cursor 443 as the copy source or copy destination. On the other hand, in the case that the selection mode is in edit list mode, the finalizing button 448 is operated when finalizing the edit list file corresponding to the position of the cursor 443 as the edit list file corresponding to the sub-clip to be edited (hereafter called the object edit list file).

In the example in FIG. 30, the user operates the disk selection mode button 444 to set the selection mode as disk mode. Note that with the example in FIG. 30, the cursor 443 is displayed at the disk name display portion 441A.

In the event that the cursor is first displayed at the disk name display portion 441A, the user displays the name of the optical disk serving as the copy source (in the example of FIG. 30, “Disc2”) to the disk name display portion 441A corresponding to the position of the cursor 443, by operating the upper direction button 446A or lower direction button 446B, for example, and operates the finalizing button 448. Thus, as shown in FIG. 30, the name and create date/time of the edit list recorded on the optical disk 22A corresponding to the name displayed in the disk name display portion 441A, i.e. the optical disk 22A chosen as the copy destination is displayed at the edit list display portion 441B.

Next, the user moves the cursor 443 to the position corresponding to the disk name display portion 442A by operating the right direction button 447B. The user then displays the name of the optical disk serving as the copy destination (in the example of FIG. 30, “Disc1”) to the disk name display portion 442A by operating the upper direction button 446A or the lower direction button 446B, and operates the finalizing button 448. Thus, as shown in FIG. 30, the name and create date/time of the edit list recorded in the optical disk 21A corresponding to the name displayed in the disk name display portion 442A, i.e. the optical disk 21A chosen as the copy destination is displayed at the edit list display portion 442B.

After this, upon the user operating the edit list selection mode button 445 to set the selection mode to edit list mode, as shown in FIG. 31, the cursor 443 is displayed in a position corresponding to the name of the edit list file (E0001) and the create date/time thereof (2006.3.15.09:25:11) which is displayed in the first row of the edit list display portion 441B, for example.

Now the user operates the upper direction button 446A or lower direction button 446B to move the cursor 443 to a position corresponding to the desired edit list file, for example, and operates the finalizing button 448. Thus, the edit list file corresponding to the cursor 443 is chosen as the edit list file from the copy source.

Next, the user operates the right direction button 447B to move the cursor 443 to the edit list display portion 442B, for example, and further by operating the upper direction button 446A or lower direction button 446B, moves the cursor 443 to a position corresponding to the desired edit list file. Then the user operates the finalizing button 447 to finalize the edit list file corresponding to the cursor 443 as the edit list file for the copy destination.

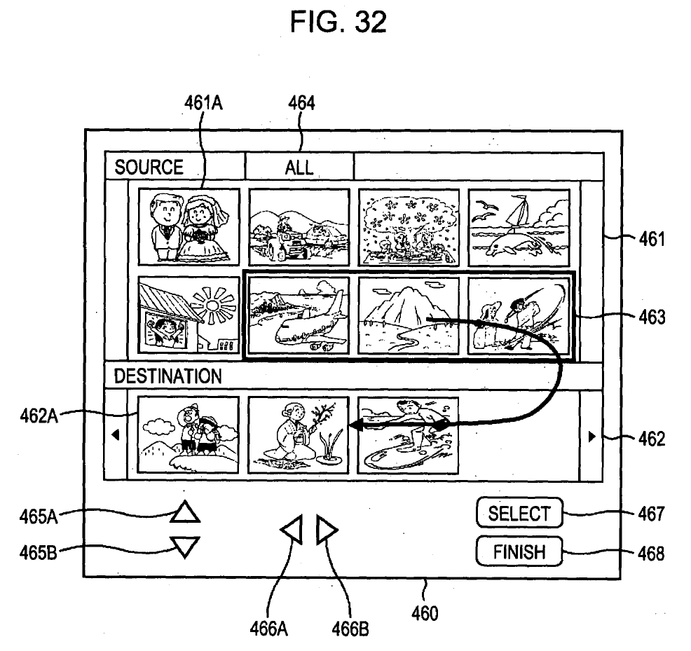

Thus, upon the optical disks serving as the copy source and copy destination, as well as the edit list files for the copy source and copy destination, being chosen, the edit object specifying screen 440 is changed to the margin setting screen 170 in FIG. 8 as described above. Upon the user operating the finalizing button 175 at the margin setting screen 170, the margin setting screen 170 is changed to the editing screen 460 in FIG. 32.

The editing screen 460 in FIG. 32 comprises an edit object display portion 461, editing result display portion 462, cursor 463, ALL button 464, upper direction button 465A, lower direction button 465B, left direction button 466A, right direction button 466B, selection button 467, and finish button 468.

The thumbnail pictures 461A of the sub-clips corresponding to the edit list file from the copy source, which are recorded in the optical disk 22A serving as the copy source, are displayed at the edit object display portion 461 in the order from the top left to the top right, and from the bottom left to the bottom right. In the example in FIG. 32, thumbnail pictures 461A from eight sub-clips corresponding to the edit list files from the copy source are displayed.

The thumbnail pictures 462A of the sub-clips corresponding to the edit list file for the copy destination, which are recorded in the optical disk 21A serving as the copy destination, are displayed at the edit object display portion 462 in playback sequence from left to right. In the example in FIG. 32, thumbnail pictures 462A from three sub-clips corresponding to the edit list files for the copy destination are displayed.

The cursor is displayed at a position corresponding to the thumbnail picture 461A displayed at the edit object display portion 461. The cursor 463 is operated when the user selects the thumbnail picture 461A of the desired sub-clip, and is moved to a position corresponding to the display position of the desired thumbnail picture 461A of the user.

The ALL button 464 is operated when selecting all of the sub-clips corresponding to the edit list files for copy source, which are recorded in the optical disk 22A as objects to be edited.

The upper direction button 465A is operated when moving the cursor 463 in the upper direction, and the lower direction button 465B is operated when moving the cursor 463 in the lower direction. The right direction button 466A is operated when moving the cursor 463 in the right direction, and the left direction button 466B is operated when moving the cursor 463 in the left direction.

The selection button 467 is operated (clicked) when selecting the thumbnail picture 461A corresponding to the cursor 463. Also, the selection button 467 is double-clicked when selecting multiple thumbnail pictures 461A. In the event that the user continues to operates the upper direction button 465A, lower direction button 465B, left direction button 466A, or right direction button 466B after double-clicking the selection button 467, the cursor is displayed so as to surround all of the thumbnail pictures 461A, from the thumbnail picture 461A corresponding to the position at the time of operation starting to the thumbnail picture 461A corresponding to the position at the time of operation ending, and so all of the thumbnail pictures 461A corresponding to the cursor 463 are selected. The finish button 468 is operated when ending the editing.

When the editing screen 460 in FIG. 32 is displayed on the picture monitor 44, the user operates the upper direction button 465A or lower direction button 465B, or the right direction button 466A or left direction button 466B, to move the cursor 463 to the thumbnail picture 461A of the sub-clip to be edited. Then by the user operating the selection button 467, the sub-clip corresponding to the thumbnail picture 461A is selected as an object to be edited.

In the example in FIG. 32, upon the user moving the cursor 463 to the sixth thumbnail picture 461A, the cursor is displayed at a position corresponding to the sixth through eighth thumbnail pictures 461A by continuing to operate the right direction button 466B until the cursor 463 moves to the eighth thumbnail picture 461A. After this, the user operates the selection button 467 to select the sub-clip corresponding to the sixth through eighth thumbnail pictures 461A corresponding to the cursor 463, as objects to be edited.

Also, the user updates the edit list file for the copy destination, by dragging and dropping the thumbnail pictures 461A corresponding to the cursor 463 to the desired position within the edit result portion 462.

With the example in FIG. 32, the sixth through eighth thumbnail pictures 461A corresponding to the cursor 463 are dragged and dropped between the second and third thumbnail pictures 462A of the three thumbnail pictures 462A displayed at the edit result display portion 462. Thus, the recording control unit 92 updates the edit list file corresponding to the edit result display portion 462 so that the sub-clip corresponding to the sixth through eighth thumbnail pictures 461A is played back following the sub-clip corresponding to the second thumbnail picture 462A.

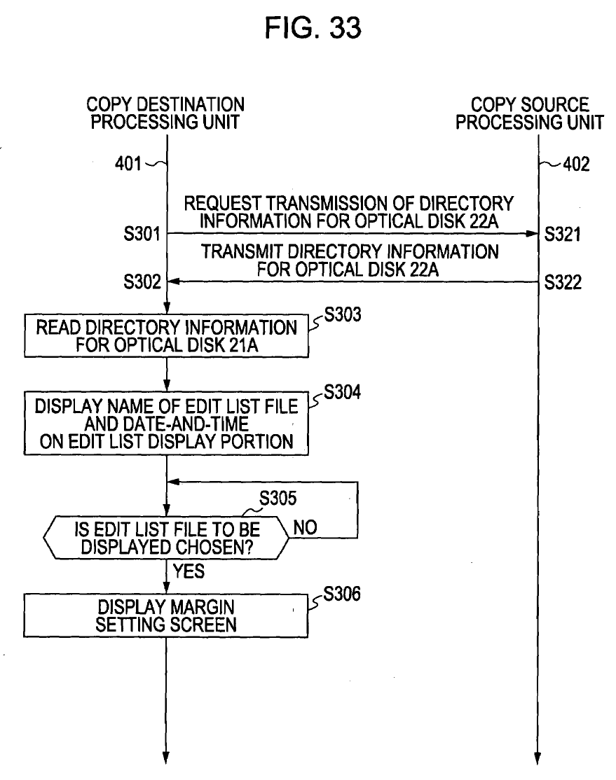

Next, the pre-consolidating processing performed by the consolidating unit 400 in FIG. 29 before consolidating the editing data will be described with reference to FIG. 33. This pre-consolidating processing is started, for example, by the user operating the operating unit 42 at the edit object selection screen 440, thus finalizing the optical disk 21A as the copy destination and finalizing the optical disk 22A as the copy source.

The processing in steps S301 through 303 are the same as the processing in steps S1 through S3 in FIG. 14, and the processing in steps S321 and 322 are the same as the processing in steps S11 and S23 in FIG. 14, so the description thereof will be omitted.

In step S304, the display control unit 93 displays the name and date/time of the edit list file recorded in the optical disk 22A at the edit list display portion 441B of the edit object selection screen 440, based on the directory information of the optical disks 21A and 22A, and displays the name and date/time of the edit list file recorded in the optical disk 21A at the edit list display portion 442B.

Now the user operates the edit list selection mode button 445 to display the cursor 443 at the edit list display portion 441B or 442B, and chooses the edit list file to serve as the edit list file for the copy source or copy destination out of the edit lists recorded in the copy source or copy destination.

Following the processing in step S304, the flow is advanced to step S305, and the receiving unit 91 determines whether or not the edit list files for the copy source and copy destination have been chosen, and in the event determination is made that the edit list files for the copy source and copy destination have not been chosen, the flow stands by until the edit list files for the copy source and copy destination have been chosen.

On the other hand, in the event that determination is made in step S305 that the edit list files for the copy source and copy destination have been chosen, the flow is advanced to step S306, wherein the display control unit 93 displays the margin setting screen 170, and the processing is ended.

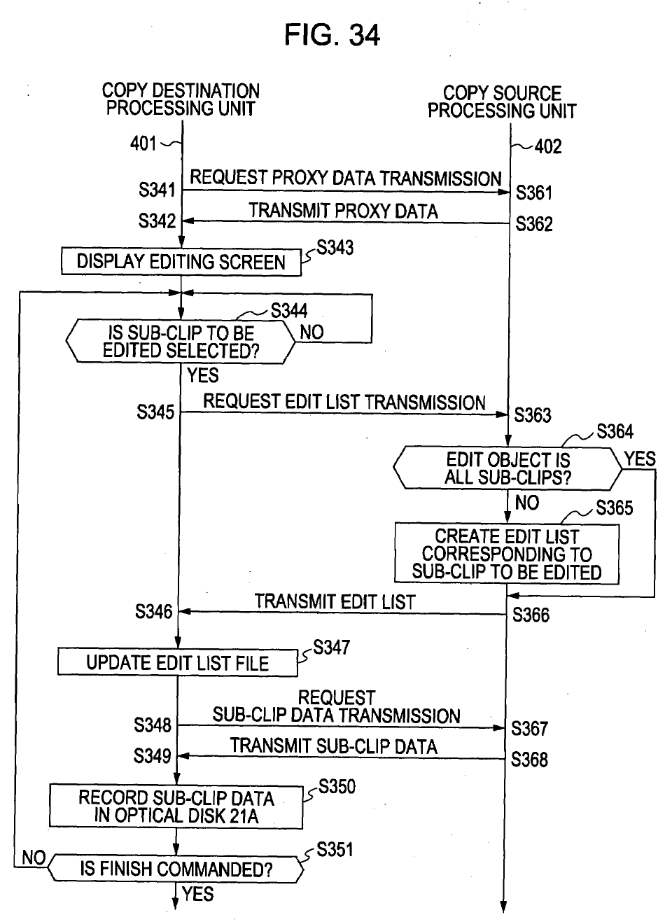

After this, upon the user choosing the margin time as 0 seconds at the margin setting screen 170, the consolidating unit 400 performs the processing without margin in FIG. 34.

In step S341 in FIG. 34, the display control unit 91 of the copy destination processing unit 401 requests transmission of proxy data of the sub-clips corresponding to the edit list file from the copy source which has been chosen at the edit object specifying screen 400 in FIG. 31, from the reading unit 421 of the copy source processing unit 402, and the flow is advanced to step S342.

In step S361, the reading unit 421 receives the request transmitted from the display control unit 93, and the flow is advanced to step S362. In step S362, the reading unit 421 reads the proxy data of the sub-clip of which transmission has been requested by the display control unit 93 and transmits this to the display control unit 93, and the flow is advanced to step S363.

In step S342, the display control unit 93 receives the proxy data transmitted from the reading unit 421, and the flow is advanced to step S343. In step S343, the display control unit 93 reads the proxy data of the sub-clip corresponding to the edit list file for the copy destination, which has been chosen at the edit object specifying screen 440 in FIG. 31, and using the proxy data as well as the proxy data received from the reading unit 421, displays the editing screen 460 in FIG. 32 on the picture monitor 44.

Specifically, the display control unit 93 creates thumbnail picture data using proxy data from the reading unit 421, and displays this at the edit object display portion 461. Also, the display control unit 93 creates thumbnail picture data using proxy data read from the optical disk 21A, and displays this at the edit result display portion 462. Further, the display control unit 93 displays the cursor 463, ALL button 464, upper direction button 465A, lower direction button 465B, left direction button 466A, right direction button 466B, selection button 467, and finish button 468.

Now the user operates the upper direction button 465A, lower direction button 465B, left direction button 466A, or right direction button 466B to display the cursor 463 at a position corresponding to the thumbnail picture 461A of the sub-clip serving as an edit object, or to select the sub-clip to be edited by operating the ALL button 464 then operating the selection button 467.

Following the processing in step S343, the flow is advanced to step S344, wherein the display control unit 93 determines whether or not the sub-clip to be edited is selected, according to the operating signals from the receiving unit 91, i.e. whether or not the selection button 467 is operated at the editing screen 460. In the event that determination is made in step S344 that the sub-clip to be edited is not selected, the flow stands by until the sub-clip to be edited is selected.

On the other hand, in the event that determination is made in step S344 that the sub-clip to be edited is selected, the flow is advanced to step S345, wherein the recording control unit 411 requests transmission of the edit list corresponding to the sub-clip to be edited from the reading unit 421.

In step S363, the reading unit 421 receives a request supplied from the recording control unit 411 in step S345, and the flow is advanced to step S363. In step S364, the reading unit 421 reads the edit list file from the copy source from the optical disk 22A, and determines whether or not the sub-clip to be edited is all of the sub-clips corresponding to the edit list file from the copy source, i.e. whether or not the ALL button 464 is operated at the editing screen 460.

In the event that the reading unit 421 determines in step S364 that the sub-clip to be edited is all of the sub-clips corresponding to the edit list file from the copy source, the edit list of the edit list file from the copy source is set as the edit list corresponding to the sub-clip to be edited, step S365 is skipped, and the flow is advanced to step S366.

On the other hand, in the event that determination is made in step S364 that the sub-clip to be edited is not all sub-clips corresponding to the edit list file from the copy source, the flow is advanced to step S365, and the reading unit 421 creates an edit list corresponding to the sub-clip to be edited, based on the edit list file from the copy source which has been read in step S364. Specifically, the reading unit 421 deletes description relating to sub-clips other than the sub-clip to be edited from the description of edit list files from the copy source, and arranges the resulting edit list to be the edit list corresponding to the sub-clip to be edited.

In step S366, the reading unit 421 transmits the edit list corresponding to the sub-clip to be edited to the recording control unit 411, and the flow is advanced to step S367.

In step S346, the recording control unit 411 receives the edit list transmitted in step S366, and the flow is advanced to step S347. In step S347, the recording control unit 411 updates the edit list file for copy destination which is recorded in the optical disk 21A so that the sub-clip to be edited is played back at the playback point-in-time corresponding to the position within the edit result display portion 462 wherein the thumbnail picture 461A has been dropped at the editing screen 460, based on the edit list transmitted from the reading unit 421.

For example, as shown in FIG. 32, in the event that the sixth through eighth thumbnail pictures 461A displayed at the edit object display portion 461 are dragged and dropped between the second and third thumbnail pictures 462A displayed at the edit result display portion 462, the recording control unit 411 updates the edit list files for copy destination which are read from the optical disk 21A, so that the sub-clip corresponding to the sixth through eighth thumbnail pictures 461A is played back between the playback of the sub-clips corresponding to the second and third thumbnail pictures 462A, based on the edit list from the reading unit 421.

Following processing of the step S347, the flow is advanced to step S348, wherein the recording control unit 411 requests transmission of the sub-clip data of the sub-clip to be edited, and the flow is advanced to step S349.

In step S367, the reading unit 421 receives a request transmitted from the recording control unit 411, and the flow is advanced to step S368. In step S368, the reading unit 421 reads the sub-clip data of which transmission has been requested by the recording control unit 411 from the optical disk 22A and transmits this to the recording control unit 411, and the processing is ended.

In step S349, the recording control unit 411 receives sub-clip data transmitted from the reading unit 421, and the flow is advanced to step S350. In step S350, the recording control unit 411 records the sub-clip from the received sub-clip data as a clip file onto the optical disk 21A, and also records the non-real-time metadata as a metadata file.

Following the processing in step S350, the flow is advanced to step S351, wherein the display control unit 93 determines whether or not the user has commanded ending the editing of the sub-clip recorded in the optical disk 22A, i.e. whether or not the finish button 468 is operated, and in the event determination is made that ending is not commanded, the flow returns to step S344, and the above-described processing is repeated.

On the other hand, in step S351, in the event that determination is made that the user has commanded the editing of the sub-clip recorded in the optical disk 22A to be ended, the consolidating processing without margin is ended.

Next, a case wherein the optical disk 21A is chosen for both the copy destination and copy source will be described with the edit object specifying screen 440 in FIG. 31.

In this case, the recording control unit 411 performs non-linear editing for a sub-clip corresponding to an edit list recorded in the optical disk 21A, according to operating signals from the receiving unit 91. Specifically, the recording control unit 411 creates a new edit list based on the operating signal from the receiving unit 91 and the edit list recorded in the optical disk 21A, and records this on the optical disk 21A. Also, the reading unit 421 of the copy source processing unit 402 performs no processing.

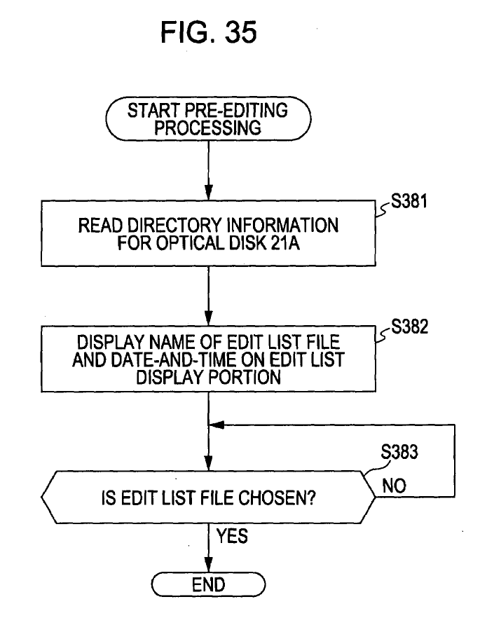

The pre-editing performed by the consolidating unit 400 in FIG. 29 before editing the sub-clip recorded in the optical disk 21A will be described with reference to FIG. 35. This pre-editing processing is started, for example, when the user operates the operating unit 42 to choose the optical disk 21A as both the copy destination and copy source at the edit object selection screen 440.

In step S381, the display control unit 93 reads the directory information (FIG. 4) of the files recorded to the optical disk 312A, and the flow is advanced to step S382.

In step S382, the display control unit 93 displays the name and date/time of the edit list file recorded in the optical disk 21A at the edit list display portions 441B and 442B of the edit object selection screen 440.

Following processing of step S382, the flow is advanced to step S383, wherein the receiving unit 91 determines whether the edit list file for copy source and copy destination has been chosen, and in the event determination is made that the edit list file for copy source and copy destination has not been chosen, the flow stands by until the edit list file for copy source and copy destination has been chosen.

On the other hand, in the event that the edit list file for copy source and copy destination has been chosen, the processing is ended.

After this, the consolidating unit 400 in FIG. 29 performs editing processing to edit the sub-clip.

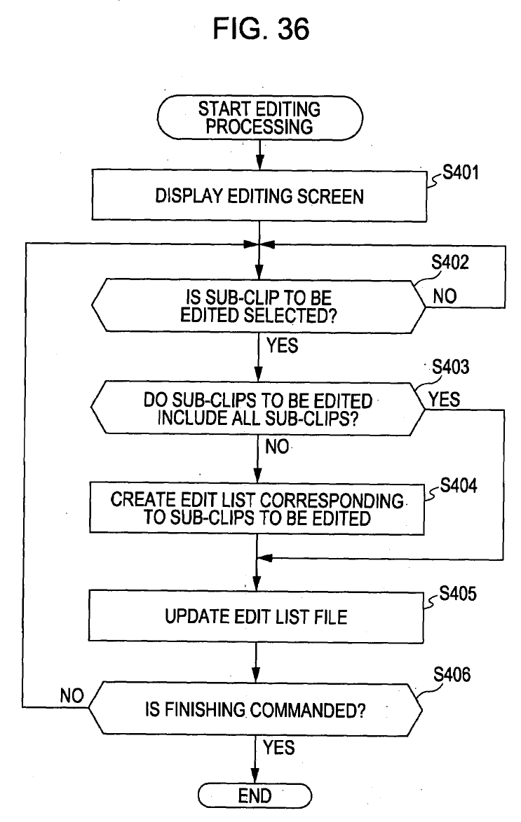

In step S401 in FIG. 36, the display control unit 93 reads the proxy data of the sub-clip corresponding to the edit list file for copy source and copy destination chosen at the edit object specifying screen 440 in FIG. 31 from the optical disk 21A, and using the proxy data therefrom, displays the editing screen 460 in FIG. 32 on the picture monitor 44.

Specifically, the display control unit 93 creates thumbnail picture data using proxy data corresponding to the edit list file for copy source, and displays this at the edit object display portion 461. Also, the display control unit 93 creates thumbnail picture data using the proxy data corresponding to the edit list file for copy source, and displays this at the edit result display portion 462. Further, the display control unit 93 displays the cursor 463, ALL button 464, upper direction button 465A, lower direction button 465B, left direction button 466A, right direction button 466B, selection button 467, and finish button 468.

Following processing in step S401, the flow is advanced to step S402, the display control unit 93 determines whether or not the sub-clip to be edited is selected according to operating signals from the receiving unit 91. In the event that determination is made in step S402 that the sub-clip to be edited is not selected, the flow stands by until the sub-clip to be edited is selected.

On the other hand, in the event that determination is made that the sub-clip to be edited is selected, the flow is advanced to step S403, wherein the recording control unit 411 reads the edit list file from copy source from the optical disk 21A, and determines whether or not the sub-clip to be edited is all sub-clips corresponding to the edit list file from copy source.

In the event that determination is made in step S403 that the sub-clip to be edited is all sub-clips corresponding to the edit list file from the copy source, the recording control unit 411 arranges the edit list of the edit list file from the copy source to be the edit list corresponding to the sub-clip to be edited, and step S404 is skipped and the flow is advanced to step S405.

On the other hand, in the event that determination is made that the sub-clip to be edited is not all sub-clips corresponding to the edit list file from the copy source, the flow is advanced to step S404, wherein the recording control unit 411 creates an edit list corresponding to the sub-clip to be edited, based on the edit list file from the copy source which is read in step s403, and the flow is advanced to step S405.

In step S405, the recording control unit 411 updates the edit list file for the copy destination so that the sub-clip to be edited is played back at the playback point-in-time corresponding to the position within the edit result display portion 462 wherein the thumbnail picture 461A has been dropped at the editing screen 460, based on the edit list corresponding to the sub-clip to be edited.

Following the processing in step S405, the flow is advanced to step S406, wherein the display control unit 93 determines whether or not the user has commanded the end of editing, i.e. whether or not the finish button 468 is operated, and in the event determination is made that ending has not been commanded, the flow is returned to step S402, and the above-described processing is repeated.

On the other hand, if determination is made in step S406 that the user has commanded the end of editing, the editing processing is ended.

Note that with the present embodiment, the unprocessed data has been described as being recorded on an optical disk, but recordings can be made onto a magnetic disk, optical magnetic disk, memory card, removable hard disk drive, or the like, for example.

With the present Specification, the steps describing a program stored in a program recording medium include processing performed in a time-series manner in the sequence described, but the invention is not restricted to the processing being performed in a time-series manner, and may be executed concurrently or individually.

Also, with the present Specification, the term “system” refers to an entirety of devices configured of multiple devices.

Note that the embodiments of the present invention are not restricted to the above-described embodiments, and that various modifications may be made without departing from the essence of the invention. That is, it should be understood by those skilled in the art that various modifications, combinations, sub-combinations and alterations may occur depending on design requirements and other factors insofar as they are within the scope of the appended claims or the equivalents thereof.

What is claimed is:

1. A recording control device whereby data recorded on a first recording medium is recorded on a second recording medium, said device comprising:
a receiving unit configured to receive a command from a user relating to editing; and
a recording control unit configured to create creating editing information serving as information relating to the editing results of the data recorded on said first and second recording medium, and record the creating editing information on said second recording medium, and also to record, to said second recording medium, creating editing data serving as data which is, of the data recorded on said first recording medium data, data configuring editing results corresponding to said creating editing information.

2. The recording control device according to claim 1, further comprising a display control unit configured to display thumbnail pictures;
wherein said data is picture data:
and wherein said display control unit displays thumbnail pictures corresponding to the picture data recorded on said first or second recording medium;
and wherein said receiving unit receives commands relating to said editing according to operations by the user as to the thumbnail pictures displayed with said display control unit.

3. The recording control device according to claim 2, wherein said display control unit displays a first thumbnail picture corresponding to picture data recorded on said first or second recording medium in a first display region, and also displays a second thumbnail picture corresponding to said creating editing data in a second display region;
and wherein said receiving unit receives a command relating to said editing corresponding to operations for moving the first thumbnail picture to a predetermined position on said second display region;
and wherein, according to commands received at said receiving unit, said recording control unit creates said creating editing information with picture data corresponding to said first thumbnail picture serving as an object of said operations, as picture data of a playback sequence corresponding to said predetermined position configuring said editing results, and records said creating editing information on said second recording medium, and also records the creating editing data from the data recorded on said first recording medium onto said second recording medium.

4. The recording control device according to claim 1, wherein said recording control unit creates said creating editing information and records said creating editing information on said second recording medium,
and wherein said creating editing data from the data recorded on said first recording medium and the data of a predetermined length before and after the playback sequence of the creating editing data, is recorded on said second recording medium.

5. The recording control device according to claim 1, wherein said recording control unit further adds data of a predetermined length before and after the playback sequence of said creating editing data, to said creating editing data recorded on said second recording medium.

6. The recording control device according to claim 1, wherein first editing information serving as information relating to editing results of the data recorded on said first recording medium is recorded on said first recording medium;
and wherein second editing information serving as information relating to editing results of the data recorded on said second recording medium is recorded on said second recording medium;
and wherein, according to commands received by said receiving unit, said recording control unit creates creating editing information of the first and second editing data configuring the editing results corresponding to said first and second editing information recorded on said first and second recording media, and records the creating editing information on said second recording medium, and also records said creating editing data from said first editing data recorded on said first recording medium on said second recording medium.

7. A recording control method for a recording control device wherein data recorded on a first recording medium is recorded on a second recording medium, comprising the steps of:
receiving a command from a user relating to editing;
creating creating editing information serving as information relating to the editing results of the data recorded on said first and second recording medium according to the received command; and
recording, to said second recording medium, said creating editing information on said second recording medium, and also recording the creating editing data serving as data which is, of the data recorded on said first recording medium data, data configuring editing results corresponding to said creating editing information.

8. A program for causing a computer to execute processing wherein data recorded in a first recording medium is recorded in a second recording medium, including the steps of:
receiving a command from a user relating to editing;
creating creating editing information serving as information relating to the editing results of the data recorded on said first and second recording medium according to the received command; and
recording, to said second recording medium, said creating editing information on said second recording medium, and also recording the creating editing data serving as data which is, of the data recorded on said first recording medium data, data configuring editing results corresponding to said creating editing information from the data recorded on said first recording medium to said second recording medium.
